(19) United States
(12) Patent Application Publication
(10) Pub. No.: US 2026/0143490 A1
(43) Pub. Date: May 21, 2026

(54) FLEXIBLE LAYER 1/LAYER 2 CONTROL SIGNALING

(71) Applicant: QUALCOMM Incorporated, San Diego, CA (US)

(72) Inventor: Sony AKKARAKARAN, Poway, CA (US)

(21) Appl. No.: 18/954,440

(22) Filed: Nov. 20, 2024

(51) Int. Cl. H04W 72/20

(52) U.S. Cl. CPC H04W 72/20

(57) ABSTRACT

This disclosure provides methods and apparatuses for flexible and efficient control signaling in wireless communication networks. In various examples, an apparatus for wireless communication such as a UE or network entity may receive, from a communications device, a configuration including an encoded token associated with a unique identifier for a configuration parameter; receive from the communications device, or transmit to the communications device, a message including an indication of the unique identifier for the configuration parameter and one or more values associated with the configuration parameter; and communicate data with the communications device according to a value update or activation update of the values associated with the configuration parameter referenced in the indication. The methods and apparatuses provide reduced latency, increased flexibility, and enhanced security in updating network parameters.

### TECHNICAL FIELD

The present disclosure relates to wireless communication, and more particularly, to methods and apparatuses for flexible and efficient Layer 1 and Layer 2 control signaling in 5G and subsequent wireless networks.

### DESCRIPTION OF THE RELATED TECHNOLOGY

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

One innovative aspect of the subject matter described in this disclosure may be implemented in an apparatus for wireless communication, where the apparatus is a first communications device such as a user equipment (UE). The apparatus includes one or more memories, and one or more processors each communicatively coupled with at least one of the one or more memories. The one or more processors, individually or in any combination, are operable to cause the apparatus to receive, from a second communications device such as a network entity, a configuration including an encoded token, the encoded token being associated with a unique identifier for a configuration parameter; receive from the second communications device, or transmit to the second communications device, a message including an indication of the unique identifier for the configuration parameter and one or more values associated with the configuration parameter; and communicate data with the second communications device according a value update or an activation update of the one or more values associated with the configuration parameter referenced in the indication.

Another innovative aspect of the subject matter described in this disclosure may be implemented in a method of wireless communication performable at a first communications device such as a UE. The method includes receiving, from a second communications device such as a network entity, a configuration including an encoded token, the encoded token being associated with a unique identifier for a configuration parameter; receiving from the second communications device, or transmitting to the second communications device, a message including an indication of the unique identifier for the configuration parameter and one or more values associated with the configuration parameter; and communicating data with the second communications device according a value update or an activation update of the one or more values associated with the configuration parameter referenced in the indication.

Another innovative aspect of the subject matter described in this disclosure may be implemented in an apparatus for wireless communication, where the apparatus is a first communications device such as a network entity. The apparatus includes one or more memories, and one or more processors each communicatively coupled with at least one of the one or more memories. The one or more processors, individually or in any combination, are operable to cause the apparatus to transmit, to a second communications device such as a UE, a configuration including an encoded token, the encoded token being associated with a unique identifier for a configuration parameter; transmit to the second communications device, or receive from the second communications device, a message including an indication of the unique identifier for the configuration parameter and one or more values associated with the configuration parameter; and communicate data with the second communications device according a value update or an activation update of the one or more values associated with the configuration parameter referenced in the indication.

Another innovative aspect of the subject matter described in this disclosure may be implemented in a method of wireless communication performable at a first communications device such as a network entity. The method includes transmitting, to a second communications device, a configuration including an encoded token, the encoded token being associated with a unique identifier for a configuration parameter; transmitting to the second communications device, or receiving from the second communications device, a message including an indication of the unique identifier for the configuration parameter and one or more values associated with the configuration parameter; and communicating data with the second communications device according a value update or an activation update of the one or more values associated with the configuration parameter referenced in the indication.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1A is a diagram illustrating an example of a wireless communications system and an access network.

FIG. 1B shows a diagram illustrating an example disaggregated base station architecture.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a first communications device such as a base station and a second communications device such as a user equipment (UE) in an access network.

FIG. 4 is a diagram illustrating an example of abstract syntax notation one (ASN.1) encoded radio resource control (RRC) information elements (IEs).

FIG. 5 is a diagram illustrating an example of a pointer or indexing framework added to the RRC IEs of FIG. 4 according to one or more aspects of the present disclosure.

FIG. 6 is a call flow diagram between a UE and a base station.

FIG. 7 is a flowchart of a method of wireless communication performable at a communications device such as a UE.

FIG. 8 is a flowchart of a method of wireless communication performable at a communications device such as a network entity.

FIG. 9 is a diagram illustrating an example of a hardware implementation for an example apparatus.

FIG. 10 is a diagram illustrating another example of a hardware implementation for another example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

Currently in fifth generation (5G) wireless networks, introducing new downlink control information (DCI) and medium access control (MAC) control elements (MAC-CEs) is a labor-intensive process customized for each parameter. Whenever a new parameter needs updating, an extensive definitions effort may be applied. This repetitive and cumbersome process underscores the importance of providing for a more unified approach. It would be helpful thus to create a system where any parameter can be updated by simply indicating the parameter and its new value.

However, the current framework does not support such a streamlined indication method. For instance, existing radio resource control (RRC) messages and abstract syntax notation one (ASN.1) encoding do not facilitate a straightforward way to specify which parameter needs updating and what the new value should be. This lack of support necessitates the continuous definition of separate DCIs and MAC-CEs for each new parameter, which is inefficient and time-consuming.

One or more aspects of the present disclosure overcome this limitation by developing a more flexible and unified approach using pointers. This approach allows for the indication of any parameter in an RRC message and its new value without the need for defining new DCIs and MAC-CEs each time. As a result, the process of updating parameters in 5G networks may be significantly streamlined, enhancing efficiency and reducing the effort required for each update.

One or more aspects of the present disclosure allow the UE or base station to embed parameter indications via pointers within MAC-CEs, DCIs, uplink control information (UCI), sidelink control information (SCI), or other control information, streamline the update process, and manage varying action times. This approach enhances the flexibility and efficiency of parameter updates in 5G networks, supporting low-latency control signaling and accommodating new functionalities through multi-stage control mechanisms. By setting limits and controls on the dynamic updating process, the system can ensure efficient updates within required timeframes, maintaining network integrity and performance.

Prior approaches to updating parameters in 5G networks involved defining new MAC-CEs or DCIs for each specific update, which becomes inefficient with complex hierarchical structures. One or more aspects of the present disclosure introduce a pointer mechanism to dynamically reference different IEs, allowing for more flexible and efficient updates. This approach may handle various levels of nested structures, ensuring that parameter updates are both precise and efficient.

In one or more aspects of the present disclosure, a unique identifier may be assigned to every token or variable name in RRC messages. Each token may have an associated pointer. This approach provides a flexible and efficient way to reference and update variables, accommodating future use cases without extensive rework. While the assigned pointers may allow for dynamic updates via MAC-CEs, these pointers may also be used for other purposes, such as defining actions based on received messages.

In one or more aspects of the present disclosure, unique indices may be assigned to each IE in a specification. In one example, these pointers may be assigned to have uniqueness across multiple specifications and subgroups. In another example, different types of pointers, such as integer, floating point numbers, and structures, may form families of pointers, each with its own set of values. In another example, the indexing process may be organized by ASN.1 module to manage and interpret the indices. Thus, the network may dynamically reference and update a wide range of variables.

In one or more aspects of the present disclosure, unique indices may be provided across different domains within the 5G specifications. This domain-based uniqueness may be achieved by partitioning indices based on ASN.1 modules, data types, or other attributes, and by using additional fields to indicate the module or family to which an index belongs. Implicit assignment of indices based on one or more well-defined rules may also be provided. The UE or base station may build a table mapping indices to variables, allowing for correct interpretation of the tokens and efficient parameter updates.

One or more further aspects of the present disclosure detail base station and UE treatment of flexible MAC-CEs, DCIs, or other control information. More particularly, a flexible lower layer control framework may be provided which allows for dynamic reconfiguration and updating of various parameters in 5G networks. The flexible lower layer control framework may be, for example, a flexible MAC-CE framework, a flexible DCI framework, a flexible UCI framework, a flexible SCI framework, or a flexible framework for some other type of Layer 1 or Layer 2 control information. By defining generic instructions and leveraging activation state fields, the framework may provide a versatile control mechanism. The approach allows for appropriate parameters to be activated or deactivated, and multiple updates to be handled within a single MAC-CE or other control information, enhancing overall efficiency and flexibility. Moreover, flexible MAC-CEs or other control information may be managed in wireless networks through fixed, information element (IE)-dependent, or variable action time approaches, and through accommodation of the interaction between both non-flexible and flexible types of MAC-CEs or other control information, thus allowing the network to achieve a high level of flexibility and efficiency in updating IEs.

In one or more aspects of the present disclosure, flexible uplink MAC-CEs may be provided in which the UE requests its preferences for certain parameters via pointers, and the base station may configure the UE's parameters based on these preferences in similar flexible downlink MAC-CEs. The UE may provide multiple preferred values in order of priority, and the base station may respond by indicating the chosen or selected preference(s). The UE's preferences may be cross-coupled and the base station's responses may be similarly coupled to the UE's preferences, allowing for the base station's responses to be more compact with reduced numbers of bits to convey selected configurations. This approach allows for efficient and flexible parameter management.

In one or more aspects of the present disclosure, specific encryption schemes or general security frameworks may be applied to flexible MAC-CEs, DCIs, UCIs, SCIs, or other control information as an extension of RRC message security. In one example, a mapping between pointers such as in an ‘IEpointer’ field and parameters such as IEs may be secured with a key exchanged during an RRC configuration. In another example, other security frameworks applied to non-flexible MAC-CEs or other typical control information may be applied to flexible MAC-CEs, DCIs, UCIs, SCIs, or other control information to further enhance security.

In one or more aspects of the present disclosure, any of the aforementioned aspects may be adopted in current or subsequent wireless communication generations such as 5G, sixth generation (6G), and beyond. In one example, the pointer framework or flexible lower layer control framework previously described according to one or more of the foregoing aspects may be forwardly applied to set(s) or subset(s) of RRC parameters defined in subsequent releases, with the exclusion of RRC parameters in prior or current releases. In another example, the pointer framework or flexible lower layer control framework previously described according to one or more of the foregoing aspects may be retroactively assigned to tokens or variable names of set(s) or subset(s) of parameters defined irrespective of release, including IEs of prior, current, and future releases. In another example, the pointer framework or flexible lower layer control framework previously described according to one or more of the foregoing aspects may be assigned to set(s) or subset(s) of RRC parameters defined in certain protocols or ASN.1 modules. In another example, the pointer framework or flexible lower layer control framework previously described according to one or more of the foregoing aspects may be incorporated via an explicitly enumerated data structure of index referenceable set(s) or subset(s) of parameters.

Accordingly, various aspects of the subject matter described in this disclosure relate generally to wireless communication, and more particularly to methods and apparatuses for flexible Layer 1 and Layer 2 control signaling. Some aspects specifically relate to dynamically updating configuration parameters using unique identifiers or pointers. In various examples, apparatuses and methods are provided in which a first communications device receives, from a second communications device, a configuration including an encoded token associated with a unique identifier for a configuration parameter; receives from the second communications device, or transmits to the second communications device, a message including an indication of the unique identifier for the configuration parameter and one or more values associated with the configuration parameter; and communicates data with the second communications device according to a value update or activation update of the values associated with the configuration parameter referenced in the indication. In various examples, the first communications device may be a UE configured for downlink, uplink, or sidelink communication, a network node such as a location management function (LMF) or positioning server operating under New Radio Positioning Protocol A (NRPPa), or some other communication device operating under a signaling protocol. Similarly, in various examples, the second communications device may be a base station or other network entity configured for downlink or uplink communication, another UE configured for sidelink communication, or some other communication device operating under a signaling protocol. In various aspects, the configuration may be an RRC configuration. Additional aspects for both the first communications device and the second communications device relate to enhancing security and efficiency in parameter updates. In various aspects, the first communications device and the second communications device may communicate wirelessly over a Uu interface or a PC5 interface, wired over a backhaul interface, or wirelessly or wired over some other type of interface or link.

Thus, particular aspects of the subject matter described in this disclosure may be implemented to realize one or more potential advantages. For example, the disclosed methods and apparatuses may provide reduced latency and increased flexibility in updating network parameters. This may be achieved by a first communications device receiving, from a second communications device, a configuration including an encoded token associated with a unique identifier for a configuration parameter; receiving from the second communications device, or transmitting to the second communications device, a message including an indication of the unique identifier for the configuration parameter and one or more values associated with the configuration parameter; and communicating data with the second communications device according to a value update or activation update of the values associated with the configuration parameter referenced in the indication. In addition, the disclosed methods and apparatuses may provide enhanced security and adaptability to future network standards. These advantages can be realized through the use of encrypted identifiers and modular configuration approaches.

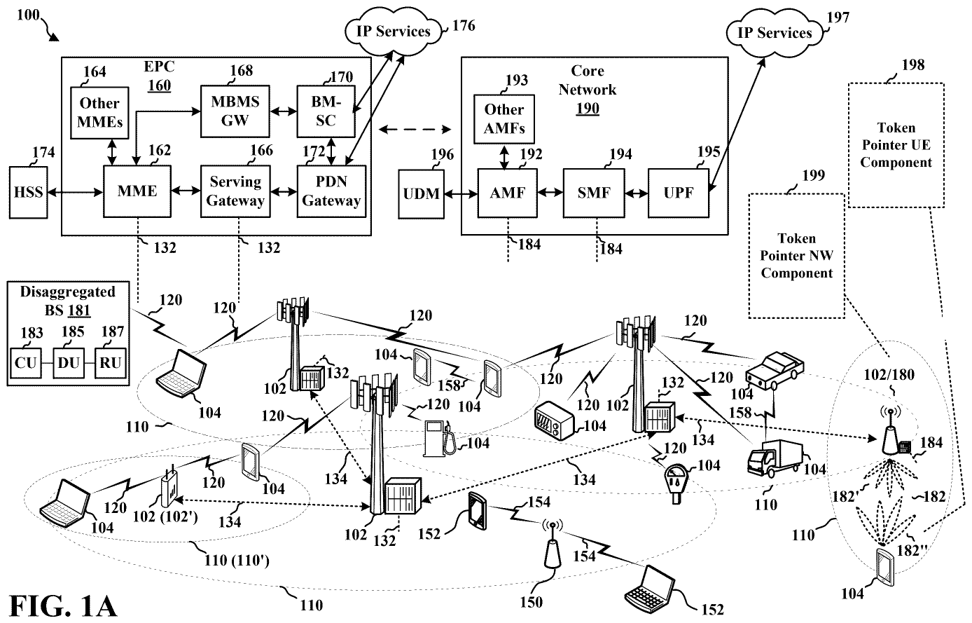

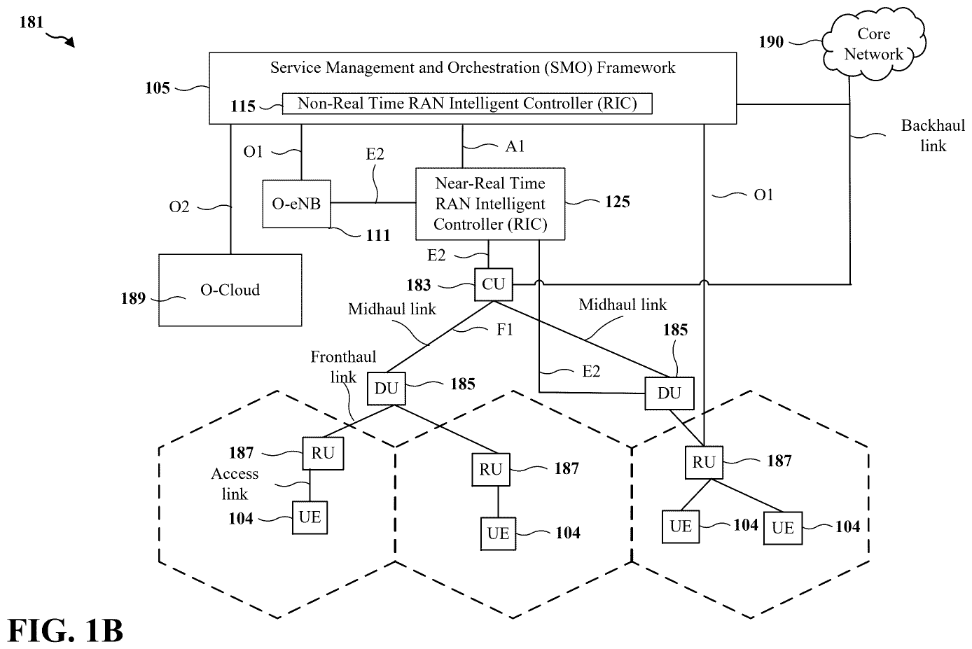

FIG. 1A is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a communications device, a wireless communications device, a remote device, a mobile subscriber station, an access terminal, a mobile terminal, a wireless terminal, a remote terminal, a handset, a user agent, a mobile client, a client, or some other suitable terminology.

Deployment of communication systems, such as 5G NR systems, may be arranged in multiple manners with various components or constituent parts. In a 5G NR system, or network, a network node, a network entity, a network device, a mobility element of a network, a RAN node, a core network node, a network element, or a network equipment, such as a BS, or one or more units (or one or more components) performing base station functionality, may be implemented in an aggregated or disaggregated architecture. For example, a BS (such as a Node B (NB), eNB, NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station 181 may be configured to utilize a protocol stack that is physically or logically distributed among two or more units (such as one or more central units (CU), one or more distributed units (DUs), or one or more radio units (RUs)). In some aspects, a CU 183 may be implemented within a RAN node, and one or more DUs 185 may be co-located with the CU, or alternatively, may be geographically or virtually distributed throughout one or multiple other RAN nodes. The DUs may be implemented to communicate with one or more RUs 187. Each of the CU, DU and RU also may be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which may enable flexibility in network design. The various units of the disaggregated base station, or disaggregated RAN architecture, may be configured for wired or wireless communication with at least one other unit.

FIG. 1B shows a diagram illustrating an example disaggregated base station 181 architecture. The disaggregated base station 181 architecture may include one or more CUs 183 that may communicate directly with core network 190 via a backhaul link, or indirectly with the core network 190 through one or more disaggregated base station units (such as a Near-Real Time RIC 125 via an E2 link, or a Non-Real Time RIC 115 associated with a Service Management and Orchestration (SMO) Framework 105, or both). A CU 183 may communicate with one or more DUs 185 via respective midhaul links, such as an F1 interface. The DUs 185 may communicate with one or more RUs 187 via respective fronthaul links. The RUs 187 may communicate respectively with UEs 104 via one or more radio frequency (RF) access links. In some implementations, the UE 104 may be simultaneously served by multiple RUs 187.

Each of the units, i.e., the CUs 183, the DUs 185, the RUs 187, as well as the Near-RT RICs 125, the Non-RT RICs 115 and the SMO Framework 105, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, may be configured to communicate with one or more of the other units via the transmission medium. For example, the units may include a wired interface configured to receive or transmit signals over a wired transmission medium to one or more of the other units. Additionally, the units may include a wireless interface, which may include a receiver, a transmitter or transceiver (such as a radio frequency (RF) transceiver), configured to receive or transmit signals, or both, over a wireless transmission medium to one or more of the other units.

In some aspects, the CU 183 may host higher layer control functions. Such control functions may include radio resource control (RRC), packet data convergence protocol (PDCP), service data adaptation protocol (SDAP), or the like. Each control function may be implemented with an interface configured to communicate signals with other control functions hosted by the CU 183. The CU 183 may be configured to handle user plane functionality (i.e., Central Unit—User Plane (CU-UP)), control plane functionality (i.e., Central Unit—Control Plane (CU-CP)), or a combination thereof. In some implementations, the CU 183 may be logically split into one or more CU-UP units and one or more CU-CP units. The CU-UP unit may communicate bidirectionally with the CU-CP unit via an interface, such as the E1 interface when implemented in an O-RAN configuration. The CU 183 may be implemented to communicate with the DU 185, as necessary, for network control and signaling.

The DU 185 may correspond to a logical unit that includes one or more base station functions to control the operation of one or more RUs 187. In some aspects, the DU 185 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 185 may further host one or more low PHY layers. Each layer (or module) may be implemented with an interface configured to communicate signals with other layers (and modules) hosted by the DU 185, or with the control functions hosted by the CU 183.

Lower-layer functionality may be implemented by one or more RUs 187. In some deployments, an RU 187, controlled by a DU 185, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 187 may be implemented to handle over the air (OTA) communication with one or more UEs 104. In some implementations, real-time and non-real-time aspects of control and user plane communication with the RU(s) 187 may be controlled by the corresponding DU 185. In some scenarios, this configuration may enable the DU(s) 185 and the CU 183 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements, which may be managed via an operations and maintenance interface (such as an O1 interface). For virtualized network elements, the SMO Framework 105 may be configured to interact with a cloud computing platform (such as an open cloud (O-Cloud) 189) to perform network element life cycle management (such as to instantiate virtualized network elements) via a cloud computing platform interface (such as an O2 interface). Such virtualized network elements may include, but are not limited to, CUs 183, DUs 185, RUs 187 and Near-RT RICs 125. In some implementations, the SMO Framework 105 may communicate with a hardware aspect of a 4G RAN, such as an open eNB (O-eNB) 111, via an O1 interface. Additionally, in some implementations, the SMO Framework 105 may communicate directly with one or more RUs 187 via an O1 interface. The SMO Framework 105 also may include the Non-RT RIC 115 configured to support functionality of the SMO Framework 105.

The Non-RT RIC 115 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 183, one or more DUs 185, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

Referring to FIGS. 1A and 1B, in certain aspects, the UE 104 may be an example of a first communications device which includes a token pointer UE component 198 that is configured to receive, from a second communications device, a configuration such as a radio resource control (RRC) configuration including an encoded token associated with a unique identifier for a configuration parameter; receive from the second communications device, or transmit to the second communications device, a message including an indication of the unique identifier for the configuration parameter and one or more values associated with the configuration parameter; and communicate data with the second communications device according to a value update or activation update of the values associated with the configuration parameter referenced in the indication. The first communications device such as UE 104 may receive such configurations and messages from, and send similar messages to, the second communications device, which for example may be another UE, base station 102/180, disaggregated base station 181, a component of disaggregated base station 181 such as CU 183, DU 185, or RU 187, or some other network entity.

Furthermore, in certain aspects, a network entity such as base station 102/180, disaggregated base station 181, or a component of disaggregated base station 181 such as CU 183, DU 185, or RU 187, may be examples of a first communications device which includes a token pointer network (NW) component 199 that is configured to transmit, to a second communications device, a configuration such as a radio resource control (RRC) configuration including an encoded token associated with a unique identifier for a configuration parameter; transmit to the second communications device, or receive from the second communications device, a message including an indication of the unique identifier for the configuration parameter and one or more values associated with the configuration parameter; and communicate data with the second communications device according to a value update or activation update of the values associated with the configuration parameter referenced in the indication. The first communications device such as base station 102/180 may send such configurations and messages to, and receive similar messages from, the second communications device, which for example may be UE 104 or a different UE.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

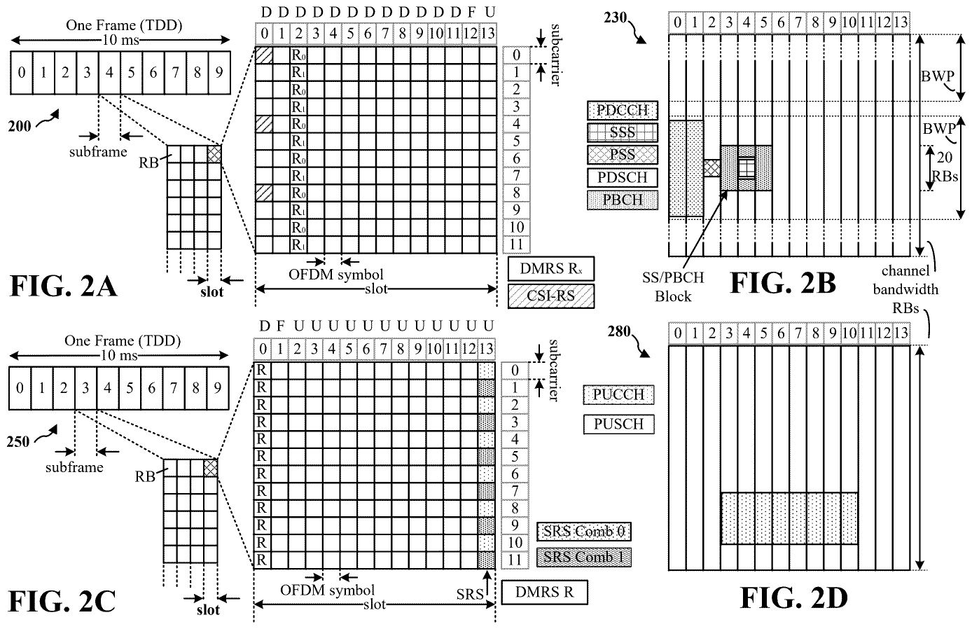

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ}slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data and may additionally be used to carry a buffer status report (BSR), a power headroom report (PHR), and/or UCI.

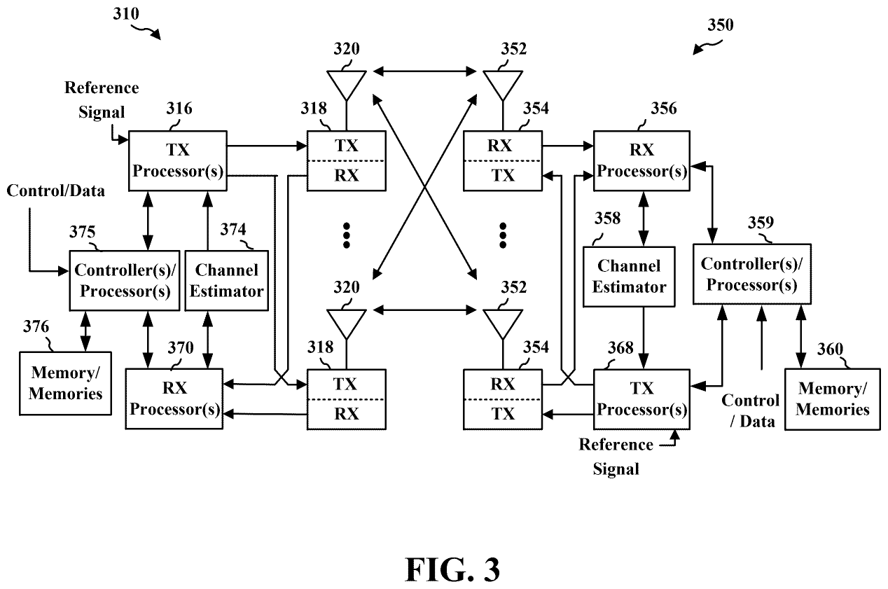

FIG. 3 is a block diagram of a communications device 310 such as base station 102/180 in communication with a communications device 350 such as UE 104 in an access network. In the DL, IP packets from the EPC 160 may be provided to one or more controllers/processors 375. The one or more controllers/processors 375 implement layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The one or more controllers/processors 375 provide RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The one or more transmit (TX) processors 316 and the one or more receive (RX) processors 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The one or more TX processors 316 handle mapping to signal constellations based on various modulation and coding schemes (MCS) (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the communications device 350. Each spatial stream may then be provided to a different antenna 320 via a separate transmitter 318TX. Each transmitter 318TX may modulate an RF carrier with a respective spatial stream for transmission.

At the communications device 350, each receiver 354RX receives a signal through its respective antenna 352. Each receiver 354RX recovers information modulated onto an RF carrier and provides the information to the one or more receive (RX) processors 356. The one or more TX processors 368 and the one or more RX processors 356 implement layer 1 functionality associated with various signal processing functions. The one or more RX processors 356 may perform spatial processing on the information to recover any spatial streams destined for the communications device 350. If multiple spatial streams are destined for the communications device 350, they may be combined by the one or more RX processors 356 into a single OFDM symbol stream. The one or more RX processors 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the communications device 310. These soft decisions may be based on channel estimates computed by the channel estimator 358. The soft decisions are then decoded and deinterleaved to recover the data and control signals that were originally transmitted by the communications device 310 on the physical channel. The data and control signals are then provided to the one or more controllers/processors 359, which implement layer 3 and layer 2 functionality.

The one or more controllers/processors 359 may each be associated with one or more memories 360 that store program codes and data. The one or more memories 360, individually or in any combination, may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). In the UL, the one or more controllers/processors 359 provide demultiplexing between transport and logical channels, packet reassembly, deciphering, header decompression, and control signal processing to recover IP packets from the EPC 160. The one or more controllers/processors 359 are also responsible for error detection using an ACK and/or NACK protocol to support HARQ operations.

Similar to the functionality described in connection with the DL transmission by the communications device 310, the one or more controllers/processors 359 provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the communications device 310 may be used by the one or more TX processors 368 to select the appropriate coding and modulation schemes, and to facilitate spatial processing. The spatial streams generated by the one or more TX processors 368 may be provided to different antenna 352 via separate transmitters 354TX. Each transmitter 354TX may modulate an RF carrier with a respective spatial stream for transmission.

The UL transmission is processed at the communications device 310 in a manner similar to that described in connection with the receiver function at the communications device 350. Each receiver 318RX receives a signal through its respective antenna 320. Each receiver 318RX recovers information modulated onto an RF carrier and provides the information to one or more RX processors 370.

The one or more controllers/processors 375 may each be associated with one or more memories 376 that store program codes and data. The one or more memories 376, individually or in any combination, may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). In the UL, the one or more controllers/processors 375 provide demultiplexing between transport and logical channels, packet reassembly, deciphering, header decompression, control signal processing to recover IP packets from the communications device 350. IP packets from the one or more controllers/processors 375 may be provided to the EPC 160. The one or more controllers/processors 375 are also responsible for error detection using an ACK and/or NACK protocol to support HARQ operations.

At least one of the one or more TX processors 368, the one or more RX processors 356, and the one or more controllers/processors 359 may be configured to perform aspects in connection with token pointer UE component 198 of FIG. 1A.

At least one of the one or more TX processors 316, the one or more RX processors 370, and the one or more controller/processors 375 may be configured to perform aspects in connection with token pointer NW component 199 of FIG. 1A.

The challenge of streamlining the process of updating parameters in 5G networks is significant. Historically, parameters were defined within Radio Resource Control (RRC) messages, which operate at Layer 3 (L3). However, the evolution of Layer 1 (L1) and Layer 2 (L2) control in 5G specifications has led to enhancement of lower-latency designs. Initially, many features introduced in early 5G releases had associated parameters signaled through the RRC protocol. As technology evolved, subsequent releases introduced mechanisms for the base station to update these RRC parameters using medium access control (MAC) control elements (MAC-CEs) at L2 signaling or downlink control information (DCIs) at L1 signaling. In some cases, the UE could request certain parameter values through corresponding uplink signaling using MAC-CEs. These mechanisms were introduced at least in part because relying solely on RRC messages resulted in significant latency. Beam management is one concept which exemplifies this evolution. Initially, there were no methods to update beams via DCI in earlier releases, but recently there has been introduced a way to achieve this. For example, in Release-17, a unified transmission configuration indicator (TCI) feature enabled DCI-based updates of beams for various downlink and uplink physical channels, which were previously only updateable via RRC or MAC-CE.

However, such advancement introduced through new DCI or MAC-CE typically accompanies significant effort. For instance, the process may involve extensive specification writing and design and implementation efforts within radio access network (RAN) working groups, specifically RAN1 and RAN2. For MAC-CEs, this includes defining the field formatting, specifying behavior upon receipt, and determining action times in different scenarios. In the case of uplink MAC-CEs, it also involves defining the associated scheduling request (SR) so that the UE can request an uplink grant when the only uplink data to send is the uplink MAC-CE. Similarly, for DCIs, the process entails defining field formatting, associated search spaces, DCI-size padding rules, and behavior and action times upon receipt. For uplink control information (UCI), it involves defining field formatting and complex multiplexing rules with various other existing UCI fields.

Additionally, new capabilities associated with supporting these new DCIs, MAC-CEs, UCIs, or other control information are often defined as capabilities for subgroups or subsets of the broad feature that motivated their definition. These capabilities can sometimes be useful beyond the context of those feature subgroups. However, enabling such use faces commercialization difficulties due to the challenges of commercializing the basic feature. This issue can be circumvented by defining a new feature or capability specifically for those DCI, MAC-CEs, UCIs, or the like independent of the broad feature, but this again requires additional effort.

It would be helpful therefore to adopt a more streamlined process for L1, L2, and L3 updating of feature parameters to avoid the aforementioned issues encountered in the 5G evolution. In particular, it would be helpful to find a more efficient approach that reduces the complexity and effort involved in specification writing, design, and implementation, while still enabling rapid updates and maintaining the flexibility and utility of new features and capabilities. Introducing new DCIs and MAC-CEs is labor-intensive and customized for each parameter. Whenever a new parameter needs updating, the same extensive effort must be repeated. This repetitive and cumbersome process underscores the importance of providing for a more unified approach. It would be helpful thus to create a system where any parameter can be updated by simply indicating the parameter and its new value. However, the current framework does not support such a streamlined indication method. For instance, existing RRC messages and abstract syntax notation one encoding do not facilitate a straightforward way to specify which parameter needs updating and what the new value should be. This lack of support necessitates the continuous definition of separate DCIs and MAC-CEs for each new parameter, which is inefficient and time-consuming.

Aspects of the present disclosure overcome this limitation by developing a more flexible and unified approach. This approach allows for the indication of any parameter and its new value without the need for defining new DCIs and MAC-CEs each time. Thus, the process of updating parameters in 5G networks may be significantly streamlined, enhancing efficiency and reducing the effort required for each update.

However, the challenge of streamlining the process for updating L1, L2, and L3 parameters for 6G and further technology is complex, providing a motivation for innovative approaches to avoid the pitfalls encountered in the evolution of 5G. These approaches attempt to address this complexity by separately defining dedicated MAC-CEs for updating each parameter in 5G networks. For example, a new MAC-CE may be defined for each specific parameter update, such as a fast beam update MAC-CE for updating beams during beam management. This beam update MAC-CE is then detailed in the specifications, indicating that upon receipt, a particular parameter, such as a beam codebook value, should be updated. While functional, this method is cumbersome and inefficient, requiring a new MAC-CE for each different parameter update, such as for beam updates, machine learning model updates, and numerous other RRC parameters.

To provide a more flexible and streamlined approach for updating parameters in wireless networks, one or more aspects of the present disclosure instead define a mechanism that allows for an RRC message to configure flexible MAC-CEs and DCIs. These flexible MAC-CEs and DCIs would serve to rapidly update certain RRC parameters, with the added capability that the parameters they update may themselves be RRC-configured or dynamically indicated. This approach may be implemented through modifications to the RRC information element (IE) parsing framework and, in some examples, by embedding the indication of which parameter to update directly within the MAC-CE or DCI itself. Such approach would eliminate the need to define a new MAC-CE or DCI for each specific update, thereby simplifying the process. Instead, the MAC-CE or DCI in one or more aspects of the disclosure would specify the parameter to be updated and the new value, streamlining the update mechanism.

With this new framework in place, the need to define a new MAC-CE or DCI for updating a specific parameter may be eliminated. Instead, the flexible MAC-CE or DCI can be reconfigured to update the parameter. This flexibility extends to parameters that may be defined in future releases or features, provided that the RRC IE definition adheres at least in part to one or more aspects of the disclosed framework. This approach not only simplifies the updating process but also allows for the wireless communication system to remain adaptable to future advancements without requiring extensive redefinitions.

However, dynamically updating arbitrary subsets of previously RRC-configured parameters presents its own set of challenges, particularly in terms of implementation and meeting relevant action times. To address these challenges, one or more aspects of the present disclosure provide schemes to manage the dynamic updating process. These schemes may broadly involve imposing different types of limits on the set of IEs that support such dynamic updating and implementing means to control the action times. By setting these limits and controls, the system may allow for updates to be performed efficiently and within required or indicated timeframes, thereby maintaining the integrity and performance of the network.

Unlike RRC updates, which have a general rule requiring updates to take effect within a relatively long timeframe such as 5 to 16 milliseconds (depending on the specific update message), MAC-CEs and DCIs are designed for low-latency control signaling with well-defined action times. In the current system, when the network sends an RRC message to the UE, the exact time at which the UE processes the message and updates the parameters is not strictly defined. This flexibility is left to the implementation on both the UE and network sides, with an understanding that it will take some period of time. In contrast, MAC-CEs and DCIs are associated with more precise action times, especially for downlink MAC-CEs, where the network commands the UE to make changes within a specific timeframe. This tight turnaround is important for low-latency control signaling.

The flexible MAC-CE according to one or more aspects of the present disclosure may instruct the UE to change a parameter to a specified value, with the parameter itself indicated within the MAC-CE. The wireless communication system may manage handling of varying action times depending on the parameter being updated. Currently, each type of MAC-CE has a single associated action time, such as three milliseconds for certain physical-layer (PHY)-level parameter updates or four milliseconds for discontinuous reception (DRX) related updates. In contrast, the flexible MAC-CE described in one or more aspects of the disclosure may accommodate different action times for different parameters within a single MAC-CE.

In some examples, one or more aspects of the present disclosure may extend to sidelink MAC-CEs and DCIs, including multi-stage control mechanisms. Sidelink communication structure may include multiple sidelink control information (SCI) stages, such as SCI-1 and SCI-2, which may occupy neighboring resource elements. SCI-1 is designed to be backward compatible with minimal changes, while SCI-2 is more flexible, allowing for new functionalities to be introduced. The indication of the SCI-2 format may be provided in SCI-1, ensuring that only UEs supporting newer features may process the new SCI-2 format. Aspects of the present disclosure may extend to such SCIs. Moreover, the concept of multi-stage control, where control messages are split across multiple stages (e.g., SCI-1, SCI-2, and potentially SCI-3), may be generalized and applied to various scenarios. Thus, aspects of the present disclosure may similarly extend to other multi-stage control messages. This approach allows for the network to provide incremental updates and introduce new functionalities without disrupting existing structures.

Thus, although various aspects of the present disclosure specifically refer to MAC-CEs and DCIs for simplicity of description, it should be readily understood that these aspects may be extended to other messages as a comprehensive and flexible control mechanism. For instance, while various aspects of the present disclosure often refer to MAC-CE (Uu) for simplicity, any of these references to MAC-CE may apply equally to sidelink MAC-CE (SL-MAC-CE). Similarly, references to DCI and UCI may also apply equally to SCI, including multiple stages of multi-stage DCI, UCI, and SCI. The aspects of the present disclosure are intended to be comprehensive and may be implemented across various control information types and stages.

One or more aspects of the present disclosure provide a novel encoding framework for RRC messages. Currently, there are limitations of the current 5G framework in efficiently updating parameters. These limitations are at least in part due to the existing structure of RRC messages and abstract syntax notation one (ASN.1) encoding. The process of encoding and decoding RRC information elements (IEs) using ASN. 1 is a significant aspect of 5G communication systems, ensuring accurate data representation and transmission between the gNodeB (gNB) and User Equipment (UE).

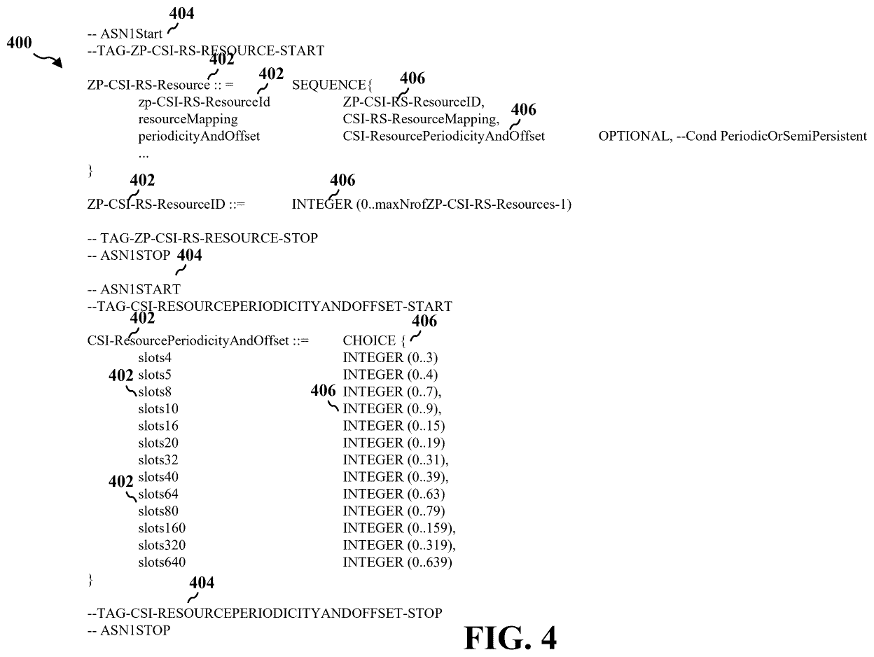

FIG. 4 illustrates an example 400 of ASN.1 encoded RRC IEs 402. In particular, FIG. 4 illustrates representative text of an RRC specification in wireless communications, which includes markers 404 such as “ASN1START” and “ASN1STOP.” These markers 404 facilitate automated parser tools to extract ASN.1 definitions and generate corresponding software code in one or more of various programming languages, such as C++. This automated process is important for maintaining consistency and accuracy in the implementation of RRC messages across different platforms and devices.

Generally, before the UE receives an ASN.1 encoded RRC message, text may be copied from the specification into a file, and a parser of or separate from the UE runs on this text to generate software code. The parser functionality may correspond to a functionality of controller(s)/processor(s) 359, 375 of communications device 310, 350 in FIG. 3, or a functionality of a separate controller or processor located outside of communications device 310, 350 such as in an external tool. The resulting generated software code is then compiled to produce a binary or executable program, which then becomes part of the UE's system for real-time parsing of received RRC messages including ASN.1 encoded RRC IEs 402. Each IE in a received RRC message corresponds to a variable in the software code. The names of these variables in the code may be closely related to their names in the specification, ensuring consistency and clarity. When the RRC message is decoded, the values assigned to these variables in the message are then assigned to the corresponding variables in the C++ code or other code applied at the UE.

Each variable in the software code may have a defined data type 406, such as integer, structure, or floating-point number. For example, an integer in the RRC message may have a specific range of values, and in the software, it could be represented as an 8-bit or 16-bit integer, depending on network or UE requirements. Some software languages allow for defining data structures that specify the exact number of bits needed for an integer, such as a 2-bit integer for values ranging from 0 to 3. This allows for the software to accurately represent the specifications of the RRC message.

The example of FIG. 4 illustrates a zero-power (ZP) channel state information reference signal (CSI-RS) resource IE, including its own IEs, parameters, or variables. In the illustrated example, a ZP-CSI-RS resource identifier (ID) ‘ZP-CSI-RS-ResourceId’ is defined as an integer variable, while the higher parameter ‘ZP-CSI-RS-Resource’ is a more complex structure with three subfields including the aforementioned ID. One of these subfields, a periodicity and offset ‘periodicityAndOffset’, is defined as a union of 13 integer subfields, such as slots4, slots5, and the like as illustrated. Unlike a C++ struct, which allocates memory for all its fields, a union holds only one of its named fields at a time, optimizing memory usage. This distinction is illustrated by the complex structure of the periodicity and offset field as evidenced through the type definition CHOICE, which may impact how data is stored and accessed within the software.

Moreover, certain data structures, such as the ‘CSI-RS-ResourceMapping’ union illustrated in the example of FIG. 4, may be used as subfields in multiple parent data structures. For example, the ‘periodicityAndOffset’ subfield may appear in the higher parameters ‘ZP-CSI-RS-Resource’, non-ZP-CSI-RS-Resource (‘NZP-CSI-RS-Resource’), and channel state information interference management (CSI-IM) resource (‘CSI-IM-Resource’) IEs. While these subfields may share the same name across different parent IEs, this naming consistency is not a requirement.

Core ASN.1 software modules play an important role in translating between the octet-streams transmitted over the air interface and the corresponding software data structures. When the UE receives a new RRC message that updates the value of ‘periodicityAndOffset’, for example, its core module parses the octet stream and updates the associated variable in the code. The core module may be, for example, a module of controller(s)/processor(s) 359, 375 of communications device 310, 350 in FIG. 3. The core module may be separate from the parser which runs on the specification text to generate the code the UE applies for octet stream parsing, such as the external tool which generates the parsing software in the UE's core module. Depending on the nature of the update, the rest of the UE software may execute additional functions. In some cases, no further action is required, and the updated value is simply used by other functions as needed.

This detailed ASN.1 encoding framework as illustrated in FIG. 4 ensures that RRC messages are precisely defined and consistently interpreted across different devices and implementations. However, each IE 402 is statically defined, and there is currently no mechanism that can generally and dynamically reference these different IEs 402 when needed. In software terminology, this concept is akin to a pointer. However, the current 5G framework lacks such a pointer mechanism which can reference different variables.

One or more aspects of the present disclosure introduce this referencing capability by providing a mechanism that allows for dynamically pointing to different IEs 402 within the RRC messages. This allows for a more dynamic and flexible way to manage and update IEs. For example, one or more aspect(s) of the present disclosure introduce a system which indexes the IE names at least shown in FIG. 4, allowing a pointer to reference different IEs 402 dynamically. In one or more aspects, a new variable may be defined that can point to different IE names, allowing the software to update various parameters as required without the need for defining new MAC-CEs for each specific update. This allows for more flexible and efficient updates to the parameters.

One approach to updating RRC IEs 402 in 5G networks involves defining a new MAC-CE or DCI for each parameter. This method is straightforward when dealing with standalone integer RRC IEs 402 such as the zp-CSI-RS-ResourceID in FIG. 4, or more generally, a simple parameter (param1, param2, param3, and the like), which is not nested within other IEs and may be introduced in different 5G releases for various features. Each MAC-CE or DCI would contain a single N-bit field that carries the new value for the respective parameter.

This approach, while effective for simple, standalone parameters, becomes cumbersome and less efficient when dealing with more complex data structures. For example, in very general terms, consider a scenario where a simple parameter named param1 is not standalone but is instead a subfield within another standalone IE named HigherParam. An example referring to FIG. 4 of HigherParam may be ZP-CS-RS-Resource. HigherParam in turn contains a subfield named subparam, which is a sequence (or array in software code) of elements of type param1. An example referring to FIG. 4 of subparam may be periodicityandOffset, which may include elements slots4, slots5, and the like of an integer type. In this case, a MAC-CE designed to update a simple parameter such as param1 in isolation is insufficient, because it does not specify which element in the subparam sequence is being updated.

To address this, two approaches can be considered. A first approach involves defining a MAC-CE or DCI that updates param1 and includes an index to identify the specific element in the sequence. This index is part of the MAC-CE and is configured so that the update is applied to the correct element. For example, referring to FIG. 4, the parameter slots10 may be the fourth parameter of a nested array given by CSI-ResourcePeriodicityAndOffset, which in turn may be the third parameter of a top-level array given by ZP-CSI-RS-Resource. To update the slots10 field, the MAC-CE may specify index 3 for the top-level array and index 4 for the nested array, along with the new value for the subfield. This method is precise but can become complex as the hierarchy deepens. A second approach involves defining a MAC-CE or DCI that updates the HigherParam field or top-level array directly. This method allows for the update of one or more elements in the sequence or even the number of elements in the sequence, providing greater flexibility. In this case, to update the slots10 field of FIG. 4 in this example, the MAC-CE may specify the third element periodicityAndOffset in the top-level array, but this time provide the entire updated structure for that element including values for slots4, slots4, slots8, slots10, and the like. This approach is efficient if multiple subfields within the structure need updating, as it allows for a comprehensive update in one instance. However, if only a single subfield needs updating, this method becomes inefficient as it requires transmitting the entire structure.

The aforementioned indexing approaches can be extended to handle even more complex cases. For example, again in very general terms, suppose there is another IE named HigherParam2, on a same level as HigherParam1, which also contains its own subparam sequence. In this scenario, a separate MAC-CE or DCI could be defined for HigherParam2, similar to the one described previously for HigherParam. Alternatively, a single MAC-CE or DCI could be designed to update either HigherParam or HigherParam2, with the MAC-CE or DCI including an identifier to specify which of these top-level structures is being updated. Moreover, further complexity may arise when dealing with an IE called EvenHigherParam, which is at a higher level than HigherParam or HigherParam2 and includes a sequence of HigherParam IEs. In the case of such nesting, an index into the sequence can be added, allowing for updates such as EvenHigherParam. HigherParam(i).subparam(j), where i and j are indices included in the MAC-CE or DCI. This approach ensures that updates can be precisely targeted to specific elements within nested sequences. The formatting of this MAC-CE or DCI may follow the lines of the first approach previously described, with two indices (i and j) and the param1 value to be updated, or it may follow the lines of the second approach previously described, with a single index (i) and the HigherParam value to be updated.

One or more aspects of the present disclosure further generalize these aforementioned approaches to handle various levels of nested structures by introducing a pointer mechanism. Using pointers, the network may dynamically reference different IEs 402, allowing for more flexible and efficient updates in control information structures. For instance, each pointer may point to standalone variables, subfields of larger structures, or even subfields within nested structures, providing a versatile approach for parameter updates in MAC-CEs and DCIs. The detailed format of these MAC-CEs or DCIs may be written using one or more indices such as described with respect to either of the aforementioned indexing approaches, depending on the specific requirements of the UE or the network. This extension of the indexing approach allows for handling complex hierarchical structures more effectively, ensuring that updates are both precise and efficient.

More particularly, one or more aspects of the present disclosure streamline the aforementioned indexing process of updating parameters in 5G networks by introducing a pointer mechanism. This mechanism assigns numeric, alphanumeric, or other identifying values to each variable name, or token, within an RRC message, allowing these variables to be referenced by their corresponding numbers, values, or other identifiers. This simplifies the process of indicating which parameter is to be updated, as the identifying value can be included in a MAC-CE or DCI.

In one or more aspects of the present disclosure, a single MAC-CE or DCI may be provided to update multiple parameters, such as param1 and param2 in the general terms previously described, without needing separate MAC-CE or DCI definitions for this purpose. This flexibility may be achieved by configuring which parameter or parameters are being updated either through a pointer indication in an RRC message that configures the operating behavior of the MAC-CE or DCI, or by a pointer indication within the MAC-CE or DCI itself. Such MAC-CEs or DCIs or other control information that references RRC IEs 402 or other parameters using pointers are described throughout this disclosure as flexible MAC-CEs, flexible DCIs, or more generally flexible control information. While such indication may be alternatively achieved by defining an enumerated list of parameters that the MAC-CE or DCI may update and including in the control information an index into this list, this approach may not be forward-compatible as the list of potential parameters would need to be redefined with each new release. Therefore, one or more aspects of the present disclosure introduce a framework where every newly defined RRC parameter is accompanied by a unique integer variable that serves as an index or pointer, although the variable may be of a different type than an index in other examples.

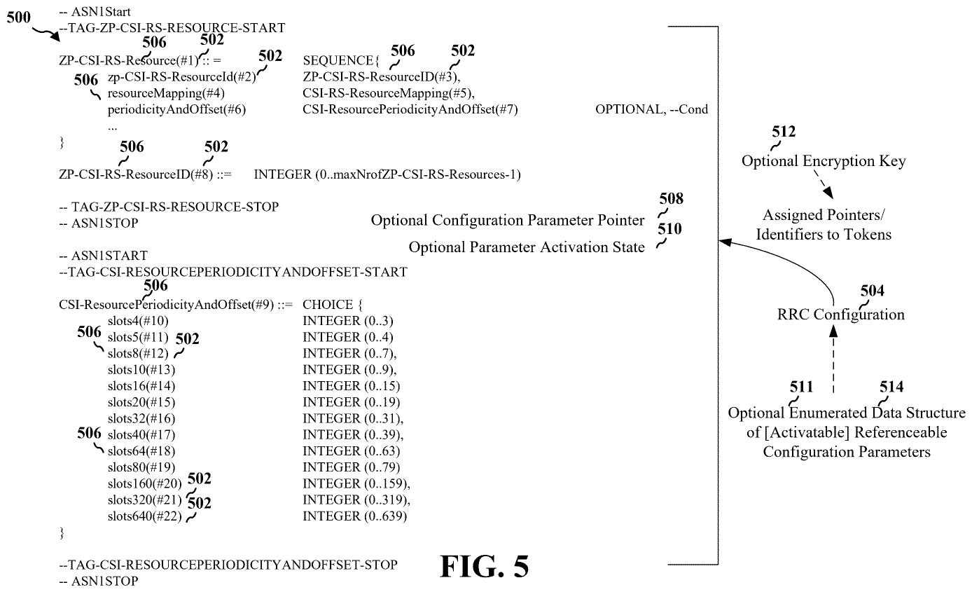

FIG. 5 illustrates an example 500 of a pointer 502 or indexing framework added to the RRC message in example 400 of FIG. 4 according to one or more aspects of the present disclosure. Each pointer 502 or unique identifier allows an associated parameter or RRC IE 402 to be uniquely referenced in other messages such as MAC-CEs and DCIs, ensuring forward compatibility. For simplicity of description, the terms pointer, unique identifier, and index are used in this disclosure interchangeably. For example, each token or variable name, such as slots10, may be assigned an index that points to it such as #13. The ZP-CSI-RS-Resource sequence, including elements such as zp-CSI-RS-ResourceId, resourceMapping, and periodicityAndOffset, each may be assigned with a unique index. The periodicityAndOffset field, defined as a CHOICE with multiple integer options each representing different slot configurations, similarly may be assigned a unique index along with its subfields. This detailed encoding ensures that each parameter may be uniquely identified and updated within flexible MAC-CEs and DCIs by its pointer, rather than by one or more indexes of top level or nested IE structures as previously described. This pointing or indexing system may also be applied to both complex and primitive constants, such as maxNrofZP-CSI-RS-Resources, which is an integer constant. By assigning an index to these constants, these fields can be referred to within flexible MAC-CEs or DCIs for purposes beyond merely updating them. Another variant of this approach may be to assign a pointer or index only to the variable name, not the type. For instance, indices may be assigned to slots4, slots5, slots8, etc., but not to the data types themselves under the SEQUENCE type illustrated such as ZP-CSI-RS-ResourceID. That is, in an alternative to the example of FIG. 5, pointers #3, #5, and #7 may be omitted in this example, simplifying the indexing process while still providing flexibility for updating parameters.

In one or more aspects of the present disclosure, each RRC variable may be an integer, such as the slot configurations shown in FIG. 5. In such case, the software code may include several variables with different names, each representing an integer. The ASN.1 module, or more generally, controller/processor 359, 375 of communications device 310, 350 in FIG. 3, may create an array of pointers to these variables in addition to the individual variable names. For instance, each element in the array such as #10, 11, #12 may respectively point to a specific integer variable such as slots4, slots5, slots8, and so forth, allowing the software to reference any variable by its pointer 502. In another example, each pointer 502 may point to a memory address that references a value in the ASN.1 encoded configuration, such as a token or variable name. For instance, when the UE receives an RRC configuration 504 including RRC IEs 402 such as illustrated in FIG. 5, its ASN.1 module, or more generally, controller/processor 359, 375 of communications device 310, 350 in FIG. 3, may extract these indexes and create a mapping table or pointer array. This table may store the indexes in consecutive memory addresses, allowing the UE to reference the correct variable based on the index provided in a MAC-CE or DCI.

Thus, the UE may be provided a configurable flexible and dynamic way to manage its variables. For instance, instead of writing code that explicitly lists each variable name, the UE may use an array of pointers or mapping table to reference variables dynamically. This method allows for the UE's software to update a list of pointers with new values, making the process more efficient and adaptable. For instance, if all the variables are integers, the system may update them by referencing their pointers 502 and assigning new values accordingly.

However, while the aforementioned simplified aspect(s) refer to a single data type of an integer for RRC variables, handling different data types 406 such as floating-point numbers adds complexity. A pointer to a floating-point number is in general different from a pointer to an integer because floating-point numbers may require more memory. For example, an integer might require four bytes, while a floating-point number might require eight bytes. Alternatively, integers and floating-point numbers might require other different numbers of bytes. Therefore, in one or more aspects of the present disclosure, pointers 502 may account for the data type 406 to correctly reference the variable or memory location. For instance, in the example of FIG. 5, pointer #10 for slots10 may indicate that slots10 is an integer type.

In one or more aspects of the present disclosure, the base station may apply these pointers 502 or token indices by including such token index as a field in a MAC-CE or DCI. However, this is not the only potential application, as there may be other scenarios where referencing a particular IE is important. For example, the token indices may also be used in configuration messages such as RRC, in addition to lower-layer messages such as MAC-CE or DCI. One example of such usage in RRC messages may be where the behavior of the flexible MAC-CE or DCI is configured via the RRC message indicating the token index. In another example, if a specific action is to be taken upon receiving certain messages or IEs, the current method involves explicitly listing all those messages or IEs in the specifications. This approach requires updating the specifications whenever a new message or IE needs to be included. In contrast, with the pointer mechanism according to one or more aspects of the present disclosure, instead of explicitly spelling out the IE names to be updated, a list of all the relevant IEs may be configured using the assigned pointers or indices. Thus, a list of IEs to be updated may be stored in some examples as #1, #2, #3, #4, for example, rather than as ZP-CSI-RS-Resource, ZP-CSI-RS-ResourceID, and so forth. This flexibility allows for dynamic updates and modifications without needing to create new versions of the specifications each time a change is required.

In one or more aspects of the present disclosure, the UE may generate a table that maps numeric indexes or other pointers 502 to variable names or tokens 506. When a MAC-CE or DCI indicates an index or pointer 502, the UE may refer to this table to determine which variable is being referenced and update it accordingly. For example, if the MAC-CE indicates index #13 is being updated, the UE may look up index #13 in its table and determine that it corresponds to the ‘slots10’ token in the RRC configuration 504. As a result, the UE may ascertain which parameter to update using whatever value the network indicates in the MAC-CE or DCI.

In one or more aspects of the present disclosure, existing text or variables from a specification such as tokens 506 may be associated with unique values such as pointers 502 for each variable name. For example, each variable or token 506 in the text may be assigned a unique number or pointer 502, such as 1, 2, 3, and so on. Once these unique identifiers are assigned, any variable can be referred to by its identifier. This identifier may then be indicated in a field within a MAC-CE or DCI, allowing the network to specify which variable is to be updated and what its new value should be.

In one or more aspects of the present disclosure, an automated parsing tool external to the UE or the base station, which is currently used to parse the text of a specification and generate corresponding software code, may be adapted to recognize the RRC format illustrated in FIG. 5. In one example, this tool may identify tokens 506 or variable names, followed by some delimiter such as round brackets containing the numeric value or other pointer 502 or unique identifier. This delimiter may indicate to the parsing tool that the value noted is a pointer to the adjacent token or variable name. The parsing tool may then build an association between the variable names and their corresponding identifiers. This association allows the UE or base station to ascertain which variable is being referenced when it receives a MAC-CE, DCI, UCI, or other control information with a numeric value or other unique identifier. For example, if the UE receives a MAC-CE instructing it to update variable #10 in FIG. 5 to a certain value, the UE may refer to its table built by the ASN.1 parsing tool(s) to determine which variable corresponds to the pointer given by #10, namely ‘slots4’. The UE may then determine exactly which parameter to update and what the new value should be for the update from the MAC-CE, without the complexity and effort required to define new MAC-CEs for updates to each specific variable. Here, the automated parsing tool(s) may correspond to, be included in, or be a functionality of, a controller or processor separate from controller/processor 359, 375 of communications device 310, 350 in FIG. 3, such as controller/processor 375 of a different UE or a controller/processor 359 of a different network entity. Alternatively, the automated parsing tool(s) may correspond to, be included in, or be a functionality of, a different device than communications device 310, 350 shown in FIG. 3, such as a different device than a UE or a network entity or some other device not shown in FIG. 3.

In one or more aspects of the present disclosure, the aforementioned pointer mechanism may be introduced into wireless specifications for RRC messages. For example, a unique alphanumeric value may be assigned to each variable name in a particular specification, allowing these variables to be referenced by their alphanumeric values in MAC-CEs and DCIs. This approach would provide more flexible and efficient updates to parameters, as the numeric value may be included in the control messages.

In one or more aspects of the present disclosure, the pointer mechanism may be implemented according to one of multiple approaches. In one example, .a single pointer may be assigned for every token 506. In another example, separate pointers may be assigned for different subsets of tokens, such as integer variables, floating-point variables, and so forth. Each subset may have its own set of pointers associated with the given data type 406 corresponding to that subset, allowing for more granular control over the updates.

In one or more aspects of the present disclosure, the pointer mechanism may be different than the nested indexing approaches previously described for updating parameters in 5G networks. For instance, in the example of FIG. 4, a MAC-CE may be provided that includes two indices to navigate nested sequences, whereas in the example of FIG. 5, the base station may assign unique numeric values to each variable name and using these values in control messages. The indices in the example of FIG. 4 would be specific to previously defined arrays in the RRC messages, while the unique identifiers in the example of FIG. 5 may be newly added pointers to the specifications. Thus, the pointer mechanism is broader and more flexible than the aforementioned indexing mechanism by allowing for the dynamic referencing of any variable in the RRC messages. By introducing unique values pointing to each variable such as shown in FIG. 5, a more generalized and efficient approach to parameter updates may be provided.

In one or more aspects of the present disclosure, various pointer mechanisms may be provided for updating parameters in 5G networks. In one example, a simple case may be provided where parameters are all of a same primitive data type, such as integers, and the framework applies pointers 502 to integers such as illustrated in the example of FIG. 5. In another example, this application may be extended to other primitive data types such as floating-point numbers or floats, characters, or double-precision floating-point numbers or double floats, with arrays of pointers for each type assigned to dynamically reference and update these variables. For scalar integer variables, the UE or base station may store a table as an array of pointers to these variables as previously described. For other primitive data types, provided they are of the same data type 406, an array of pointers to variables of that type may similarly be stored. While FIG. 5 shows the pointers appearing in the specification in brackets right next to the tokens themselves, other methods may be used to associate the pointers to the tokens. For example, a separate listing or table of all the tokens and their mapped pointers may be maintained in a specification document, for example, in an appendix of the document in which the tokens are defined. This listing or table would avoid the need for the UE or a parser tool to generate such a list. In this data structure, the tokens may be listed, including a partial or complete hierarchy of their parent or ancestor IEs within which the tokens occur, so as to be able to distinguish identical token names within different parent IEs. This list or another such data structure may also include pointers assigned to other state variable names that occur in the specifications, but not within ASN.1 IEs, such as RRC messages, including for example, RRC or MAC counters, such as N310, timers, such as DRXInactivityTimer, or the whole MAC state itself. This allows definition of flexible control signaling, such as an operation to trigger a MAC reset using a pointer to a MAC state, that can set these variables independently of their usual specification-defined operation. Such variables may also be associated with an RRC IE hierarchy, which can also be listed as part of the token name, for example, CellGroupConfig::CellConfig::BeamFailureDetectionTimer or CellGroupConfig::DRXInactivityTimer. Most RRC IEs specific for each cell may use token names with the string ‘PSCell’, such as PSCellConfig, for the PSCell of the cell-group, or ‘SCell’, such as SCellConfig, for all the SCells of the cell-group. Here, the token ‘CellConfig’ may be used to generically refer to any cell such as PSCell or SCell, or alternatively, separate tokens may be defined for PSCell and SCell.

However, in practice, parameters often have complex data types, including structures with various subfields such as illustrated in FIG. 5. To handle this complexity, type-agnostic pointers, such as “void *” in C, may be used. In such case, the UE or base station may apply another or accompanying table to store information about the data type 406 associated with the token 506, allowing the pointer 502 to be dereferenced and the data in the associated variable to be interpreted and updated correctly. For example, two tables respectively including a pointer array and a type array may be maintained at the UE or base station. The pointer array may reference the memory addresses of the variables as previously described, while the type array may provide the context needed to interpret those addresses such as the number of bits the data associated with each token occupies. This dual-table approach ensures efficient handling of both simple and complex data types.

Examples of various pointer mechanisms based on data type are described in connection with in one or more aspects of the present disclosure. For simple cases like integers or floating-point numbers, pointers 502 to these types may be individually assigned. Each variable may be numbered or identified with an index, and these indices may reference integers, characters, floats, or doubles. This approach may be extended to other primitive data types, in which the UE or base station may create separate sets of pointers for each type. In contrast, type-agnostic pointers may introduce additional complexity. These pointers do not specify the data type stored at the memory location, such as represented by a void pointer in programming languages. For instance, in FIG. 5, pointer (#9) to the data type 406 ‘CSI-ResourcePeriodicityAndOffset’ may be an example of a type-agnostic pointer to a complex data structure. To interpret such data correctly, additional information may be associated with the variables regarding the data type. For instance, for complex variables like structures, another table may be provided applying an index to each element within the structure, mapping out the data types and their locations. If a structure contains various elements of different data types, this additional accompanying table may specify the type of each element and its memory size. These two data structures, including the pointer array and the type array, may be used together to map the variables comprehensively. The pointer array may reference the tokens 506, while the type array may provide the context needed to interpret those tokens 506. Thus, the system may handle both simple and complex data types efficiently.

Further examples of pointer mechanisms are described in connection with one or more aspects of the present disclosure. When dereferencing a pointer, the UE or base station may apply information from one or more maintained tables to determine the correct memory address and interpret the data. For instance, if a pointer references an index within a structure such as pointer #13 in the example of FIG. 5, the UE or base station may consult the type array to determine the data type 406 and size of the element at that index. This allows the UE or base station to achieve an accurate reading and interpretation of the data, regardless of the data type. As an example, after determining that the pointer 502 given by #13 references a memory location including a stored value of the variable named ‘slots10’, the UE may ascertain from an accompanying table or other data structure whether this stored value is an integer or a double-precision floating-point number based on its data type 406. This information allows the UE to determine, for example, how many bytes of ‘slots10’ to read from memory and how to interpret those bytes so it can access the data correctly. For instance, if ‘slots10’ is an integer, the UE may determine to access four bytes of data from ‘slots10’'s memory, while if ‘slots10’ was a double-precision floating-point number, the UE may determine to access eight bytes of data from ‘slots10’'s memory.

Additional examples of pointer mechanisms are described in connection with one or more aspects of the present disclosure. For instance, even when the number of bytes for a token is the same between different data types, the interpretation of those bytes may differ significantly. For example, although both a regular floating-point number and an integer may each be 32 bits or four bytes, their interpretations may be different. In such case, the aforementioned accompanying table may specify the number of bytes to read and how to interpret those bytes. For instance, in the example above where ‘slots 10’ is 32 bits or four bytes, the UE or base station may determine whether this 32 bits represent an integer or a floating point number to process the data correctly. Thus, accurate updating and management of variables of different data types may be provided even with different data types sharing a same amount of memory, since the UE or base station may still be able to dereference the pointer and determine the correct data type and interpretation for each variable.

In one or more aspects of the present disclosure, each token may be assigned a unique identifier, with each unique identifier including a data type and a number. For example, a pointer “int1” may refer to an integer, while another pointer “char1” may refer to a character. This approach may be applied for a small set of primitive data types, such as a structure that contains only primitive fields or other collection of individual variables. For instance, in an alternative to the example of FIG. 5, the token ‘slots4’ may be assigned a pointer ‘int10’, the token ‘slots5’ may be assigned a pointer ‘int11’, and so forth for the entire array of primitives in CSI-ResourcePeriodicityAndOffset. Thus, elements of a structure may be given different pointer names because they represent different types of data. Generally, these elements may be defined as separate variables rather than elements of a single array. However, for the purpose of this pointer mechanism, such simple structures may still be indexed and referenced dynamically.

In one or more aspects of the present disclosure, the pointer mechanism of FIG. 5 may be limited to sufficiently simple derived types. More particularly, for complex data types such as structures or nested sequences of structures, such as ZP-CSI-RS-Resource, a different descriptor or pointer for the complex data type itself may be assigned such as #1 in FIG. 5. However, assigning an index to every token, including complex structures, may have limitations. It may result in a large number of indices, making the MAC-CEs and DCIs less compact. For instance, using a 32-bit index field may cover a vast number of indices but would also consume significant space in the control messages. To address this, in one or more aspects of the present disclosure, the assignment of pointers 502 may be limited to sufficiently simple derived types. For instance, pointers 502 may be assigned to structures such as CSI-ResourcePeriodicityAndOffset or other structures composed entirely of primitive fields, such as #9 in FIG. 5, but not to higher level structures such as #1 in FIG. 5. Thus, simple structures may have their own separate indexing, allowing them to be referenced dynamically, while more complex structures may not be indexed and may not be dynamically referenced using this pointer mechanism.

In one or more aspects of the present disclosure, an IE pointer field 508 may be included in the RRC message such as illustrated in FIG. 5. This field 508 may be set to a specific value corresponding to one of the assigned pointers, such as #203 for example, where the index #203 is assigned to a specific parameter such as a PDCCH beam index. This configuration may indicate that a subsequent flexible MAC-CE or DCI is to update the specific parameter, such as the PDCCH beam index, based on the value provided. If the IE pointer field 508 is later updated to a different value, such as #205 for example, where the index #205 is assigned to another specific parameter such as a DRX feature, then the same flexible MAC-CE may later be used to update this different parameter such as enabling or disabling the DRX feature. For example, the RRC configuration 504 shown in FIG. 5 for a flexible MAC-CE that updates only integer parameters may have field 508 named ‘fieldToBeUpdatedByThisMACCE’. This field may be of type “IEpointer” or more specifically, “integerIEpointer,” “floatIEpointer,” “structIEpointer,” or the like depending on the specific data type. If this field 508 in a received RRC message is set to an identifier such as #203, future instances of the flexible MAC-CE may update an associated parameter with that identifier such as the aforementioned PDCCH beam index. Similarly, if this field 508 in the RRC message is set to #205, the MAC-CE may instead update an associated DRX setting. As an example, the MAC-CE may indicate to the UE whether a wake-up signal (WUS) for further UE battery savings relative to connected discontinuous reception (C-DRX) is enabled or disabled. This single MAC-CE or DCI may also update multiple parameters based on its configuration, enhancing the flexibility and efficiency of parameter updates in 5G networks.

In one or more aspects of the present disclosure, different fields to be updated may utilize different additional information in order to uniquely define these fields. For instance, referring to the previous PDCCH beam index example, if the MAC-CE is updating the PDCCH beam index, it may also include a component carrier (CC) index associated with the PDCCH to be updated, at least when multiple CCs are configured. On the other hand, referring to the previous WUS example, a WUS configuration may be per cell group rather than per CC, and so if the MAC-CE is reconfigured to update the enabled or disabled status of the WUS configuration, it may include the cell-group index instead of CC index. This context-sensitive interpretation of the additional information, such as CC index or cell group index, may be determined based on the RRC IE hierarchy. For instance, the WUS configuration IE may be within the cell group configuration IE, whereas the PDCCH configuration may be within the configuration IE of each cell within the cell-group configuration IE, such as PSCell and each SCell. The determination may be implicit or explicit. In one example, the flexible MAC-CE may be defined to ensure that all the different fields it may potentially update have the same interpretation for the additional information, avoiding the need for a context-sensitive interpretation as previously described.

In one or more aspects of the present disclosure, different types of IE pointers, such as integer, float, and void, may be provided for updating parameters in wireless networks. These different data types 406 may be used to form families of pointers 502, each with their own set of unique identifiers. For instance, tokens 506 with an integer data type and tokens 506 with a floating-point data type may be assigned with identical pointer values from different sets of unique identifiers, differentiated by their data type 406. This allowing for more than one type of pointer to be configured, providing flexibility in how the pointers are assigned.

In one or more aspects of the present disclosure, additional RRC IEs 402 may be defined with each subsequent release of specifications. Along with defining these additional IEs, unique indices or pointers 502 may be assigned to them. For example, if the last assigned index to all parameters in a specification was #3400, for example, the next defined IE may be assigned index #3401, and so forth as additional IEs or parameters are defined. This process allows for each IE 402 in the specification to maintain a unique identifier for token dereferencing. More particularly, to ensure uniqueness in this example, the indices may not be assigned independently by each subgroup. Instead, a centralized process may be applied to merge all RRC updates and assign unique indices to them. Once all updates and change requests to a specification are finalized, the RRC IEs 402 may be indexed sequentially from the last assigned index in the previous release. This centralized indexing process allows for each IE to have a unique identifier across the entire specification.

In the aforementioned example, the RRC parameters or IEs 402 may all be defined in a single specification document. In such case, the latest count of assigned indices may be maintained, for example, in an appendix of the document. For example, a counter for the pointers 502 may be maintained which tracks the last assigned index to a token. When a new IE is defined or finalized, its token 506 is assigned to the next available pointer or index, and the counter is updated. However, in the typical release process, multiple features may be standardized together, and different subgroups may define different features. Each subgroup may propose new functionalities to the corresponding RRC messages, which are then compiled into the updated RRC specification. Additionally, while one RRC specification may contains most of the RRC messages, other specifications, such as a LTE positioning protocol (LPP) specification, also define messages in the same ASN.1 encoded format.

Therefore, in one or more aspects of the present disclosure, different specification documents may be interpreted as parts of a single specification document. For instance, even when IEs are split across multiple specification documents, the same counting process previously described may be applied. Thus, when new IEs are added to one specification in a set of specifications, the indexing process may account for all these specifications to maintain unique indices across the entire set of specifications. The indices may be assigned uniquely across all documents, treating them as a single entity. The counting of indices may thus be tracked as if all IEs were in a single document, providing for consistency and avoiding duplication.

Alternatively, in one or more aspects of the present disclosure, the network may assign indices separately for each specification, with each specification having its own sequence of pointers. More generally, each pointer 502 may be part of a different set of pointers associated with a specification or other group of tokens. In one example, the UE or base station may interpret a pointer for a token based on the specification document or set of pointers to which the pointer belongs. In another example, the tokens or pointers may be partitioned or organized by ASN.1 module, such as RRC parameters and LPP parameters. For instance, each ASN.1 module may be assigned with its own set of pointers, simplifying the indexing process and ensuring clarity in interpretation.

In one or more aspects of the present disclosure, a transmitting node and a receiving node, such as a base station and UE respectively in downlink communication, may track which pointer or index corresponds to which IE. In some cases, although RRC messages may contain long sequences or arrays such as shown in FIG. 5, the indexing may be applied once for the entire array, rather than for each element. This design allows it such that any additional memory required may scale with the number of tokens, which is manageable given that ASN.1 parsers generally handle the tokens. In some cases, the index may be written into the specification in a format such as (#N), as illustrated in FIG. 5, as an ASN.1 comment on the same line as the variable name, or assigned in the RRC configuration 504 in some other manner. Automatic parsing tools external to the UE or base station may then parse these indices and build a table mapping the index to the variable name such as previously described. For example, before an ASN.1 encoded RRC message is received, a tool separate from communications device 310, 350 of FIG. 3 may parse the specification document(s), prepare one or more mapping tables of pointers 502 to tokens 506, and embed the mapping table(s) into software code at the communications device 310, 350.

In one or more aspects of the present disclosure, an index or pointer 502 may be assigned to each token 506 such as illustrated in FIG. 5 including complex structures. However, as the use cases for dynamically updating complex structures may be limited, alternatively the pointers may be assigned to only a subset of tokens, particularly those of a few primitive types or sufficiently simple derived types. An example of a sufficiently simple derived type is a structure or union in which all fields are of primitive type, even if the primitive type varies among fields. The variable type information may also be included in the indexing tags, such as int1, char1, char2, double1, etc.

In one or more aspects of the present disclosure, the indices may be referenced and included in MAC-CEs and DCIs, with a parameter utilized to determine how many bits to use for each index. This parameter may be hard-wired into the specification as a constant or could be configurable. The index may be multi-part, with a few bits identifying the data type such as integer, character, double floating-point precision, or the like, and the remaining bits indicating the pointer to the variable name associated with that data type. These indices, although essentially integers or other primitive data types, may be referenced by a different name in the IE definitions, such as “IEpointer” to describe their special usage. This is analogous to how an enumerated list in the RRC specifications may have a separate name for each element, even though it may be implemented as an array of integers.

In one or more aspects of the present disclosure, unique indices may be assigned across different protocols or domains within wireless communication specifications. For example, each specification may maintain its own sequence of indices or pointers 502. In such case, the base station may indicate to which specification an index belongs. For instance, if index #3 is assigned in both the RRC specification and LPP specification to a different token, additional information may be indicated to clarify which specification or set of pointers is being referenced.

However, managing such variable pointers or indices in 5G networks may be challenging due to the numerous independently developed specifications. Therefore, in one or more aspects of the present disclosure, the partitioning of IEs into separately ASN.1 encoded modules may be leveraged. That is, IEs may partitioned into separate modules for ASN.1 encoding to address the aforementioned complexity. For example, sidelink positioning protocol (SLPP) IEs may be encoded in a separate ASN.1 module from LPP IEs and similarly from RRC IEs. This separation allows indices to overlap across different modules, with the protocol or ASN.1 module providing any disambiguation to the receiver such as the UE or base station. As these modules are compiled and parsed separately, they may have their own indexing systems. For example, indices within the SLPP module may overlap with those in the LPP module, as long as the module being parsed or compiled is indicated to the receiver. Consequently, separate families of indices can be created for different protocols or ASN.1 modules, reducing the bit width of the pointer compared to merging all IEs into a single large family.

In one or more aspects of the present disclosure, the network may explicitly indicate which module an index references. This may be achieved, for example, by adding a small field, such as a 2-bit field, in the MAC-CE or DCI to specify the module. For example, this field may indicate to the receiver whether an index pertains to a SLPP module, an RRC module, or an LPP module. This additional information allows for indices to be interpreted correctly across different modules.

In one or more aspects of the present disclosure, partitions of pointers may be created based on other attributes than specification modules, such as data type including integer, float, character, and the like, or UE capabilities. Different families of indices may be created for different data types, and a quantity of bits may be used to indicate to which family an index belongs. This approach provides flexibility and allows for efficient indexing across various attributes.

In one or more aspects of the present disclosure, as an alternative to or in addition to partitioning pointers based on protocol or ASN.1 module, explicit family partitioning of pointers may be applied. In one example, the family may be the data type. One family or set of pointers may correspond to an integer data type, another family or set of pointers may correspond to a character data type, and so forth. Thus, pointers such as ‘int1’ and ‘char2’ may be assigned to uniquely identify tokens in multiple families based on data type. In another example, pointer partitioning may be based on other criteria than data type. For instance, such criteria may include, but is not limited to, which MAC-CEs or DCIs are allowed to update associated parameters, the expected update behavior for those parameters, whether a defined UE capability is a requisite for a dynamic update of associated parameters, or whether the IE is for an uplink or downlink message. Thus, for example, uplink IEs and downlink IEs may be assigned with their own set of pointers. The family of a pointer may be indicated explicitly, such as with a quantity of bits to denote the data type, or implicitly, such as based on a logical channel identifier (LCH-id) or the type or identifier of the MAC-CE or DCI itself based on the UE's indicated capability. The family may also be an indication of a release in which a pointer is defined, for example, a tag such as-rel20,-rel21, or the like. A pointer may not be assigned to each and every token in every configuration IE, but rather a subset of tokens. This provides a mechanism to control or limit the size of a mapping table that maps the pointers to the corresponding configuration parameter. For instance, tokens representing complex, higher level IEs, which may be composed of a deeply nested hierarchy of subfield IEs, may not use pointers in some examples, because such pointers may be unlikely to be needed to more dynamically update such complex IEs using faster update mechanisms such as MAC-CE or L1 control, such as DCI, UCI, SCI, or the like. Thus, the selective assignment of pointers may reduce the memory and complexity of the logic for dereferencing the pointers. On the other hand, with this approach, it is possible that a token may not be assigned a pointer in one release of the specification, while in a later release of that specification, a use case may be found for assigning a pointer to it. Thus, the release version number in which the IE is defined may in general be identical to, or earlier than, the release version number in which a pointer is assigned for a token within the IE. To allow the UE to process specifically the tokens corresponding to its supported release version, the version number corresponding to the creation of the pointer for the token may be explicitly included with the pointer, for example, #13-rel20 or #15-rel21, instead of just for example, #13 or #15. This version number then forms another criterion by which to define a family of pointers, such as all pointers with a given version number, or with a version number equal to or less than, or equal to or greater than, a specific version number.

In one or more aspects of the present disclosure, implicit pointer creation may be applied. In this approach, the pointers illustrated in FIG. 5 such as “#1”, and its variants such as described above including “int2”, do not explicitly appear in the specification text. Instead, one or more rules may be defined for listing the IEs in a well-defined order, and pointers may be assigned based on that order. For example, referring to FIG. 5, IEs may be listed alphabetically by the “--TAG--” names that follow each marker 404 “--ASN1START--”, and then by the top IE names for multiple IEs defined within the same marker 404 “--ASN1START--”, with the pointers 502 being assigned to these IEs 402 in the aforementioned order. While this approach may impose difficulties for the receiver to look up which field is being referenced in a received MAC-CE due to the pointers not appearing in the specification, the receiver may alleviate these difficulties by building a table mapping pointers to tokens such as previously described. The difference here is instead of the UE or base station's ASN.1 parsing module mapping pointers to tokens according to an expressly indicated order as previously described, the UE or base station's ASN.1 parsing module may map pointers to tokens accordingly to an implicitly indicated order following the proposed rules.

In one or more aspects of the present disclosure, indices may be implicitly assigned based on one or more well-defined rules, rather than explicitly listing them in the specification. For instance, a specification may list tokens 506 alphabetically and assign indices or pointers 502 accordingly. Indices may be renumbered when subsequent tokens are added in subsequent releases. While the explicit listing of indices in the specification facilitates debugging, it is not a requirement as the UE may build a table mapping indices to variables and use this table to interpret indices correctly. Thus, the correct variables may still be updated even if the indices are not explicitly listed.

In one or more aspects of the present disclosure, implicit pointer creation may be implemented by treating all IEs as a single family or by creating multiple families such as previously described. If multiple families are present, one or more rules may be defined that include procedures to determine which family an IE belongs to. For example, in the case of separate indexing for UL messages versus DL messages, the automated parser of a tool external to a UE or base station may determine whether each message is downlink or uplink based on an added ASN.1 encoded tag for this purpose. For instance, referring to FIG. 5, the tag “TAG-ZP-CSI-RS-RESOURCE-START” may include “DL” or “UL” to allow the UE or base station to respectively determine whether the parameters which follow the tag are downlink or uplink, and different sets of pointers may be associated with these parameters accordingly. Unlike explicit pointers, implicit pointers may not be added at the level of every token, for example using (#10) as shown in FIG. 5, but at a higher level, such as along with each “--TAG--” name in the RRC configuration.

Typically, managing MAC-CEs may involve defining specific behaviors and actions associated with their receipt and processing. These behaviors may include the definition of fields, the actions upon receipt of the MAC-CE, and the timing of these actions, allowing for the MAC-CEs to function correctly and efficiently within the network. Currently, there are various different types of MAC-CEs, each with specific instructions on what to do upon reception. For example, some MAC-CEs activate or deactivate functionalities like secondary cells in carrier aggregation. These MAC-CEs may be explicitly named, such as “cell activation MAC-CE”, with detailed actions specified, like activating or deactivating a cell. The behaviors associated with the receipt of such MAC-CEs are well-defined in MAC specifications. These behaviors may include informing the lower layers about the received MAC-CE, activating or deactivating the relevant functionality, and performing specific actions described in the specification. Functionalities that may be activated or deactivated include component carriers (CC)/secondary cells (SCell), reference signal (RS) resource sets, transmission configuration indicator (TCI) states, measurement gaps, processing windows, and the like.

In one or more aspects of the present disclosure, any of the aforementioned aspects of the pointer framework of the present disclosure may be provided in flexible MAC-CEs, flexible DCI, or other flexible control information. A flexible MAC-CE may be a MAC-CE that is reconfigured to update different parameters over time, for example, using the aforementioned pointer framework shown in FIG. 5. For instance, this MAC-CE may initially update PDCCH beam index and later, after reconfiguration, update a DRX configuration. For flexible MAC-CEs, one or more of the following behaviors may be defined, including informing the lower layers, performing a specific action in a generic manner across various types of parameters, and activating or deactivating certain fields. Here, the performance of a specific action may be described generically, such as to update indicated parameters with their indicated values, with the new values taking effect at specified times. This generic description allows for flexibility in handling different types of parameters that the MAC-CE could be updating.

Activation and deactivation of certain fields in a flexible MAC-CE may be managed in multiple ways. In a first approach, an explicit “activationState” field, or more generally, a field 510 corresponding to a parameter's activation state, may be defined in the RRC IE definition which uses the aforementioned pointer framework to update that field. For instance, this field 510 may have multiple values indicating the activation state of a pointer-referenced or associated parameter, such as “active,” “inactive,” or “dormant”, and the value of field 510 may be indicated in the MAC-CE with a pointer to that field 510 for dynamic updates. In a second approach, the MAC-CE may be defined itself to activate or deactivate a parameter or functionality. In such case, activation is indicated via a field in the MAC-CE itself, rather than via updates of the value of the field 510 in the RRC IE. In this approach, the MAC-CE may carry a pointer to the parameter being updated, as well as carry the activation command such as activate, deactivate, or toggle state. This “activationState” field or similar field in the MAC-CE may be associated with the RRC fields to which this MAC-CE points through a description of the IE or field in the specification, rather than through an explicit field in the IE definition itself such as field 510. Certain IEs may be described as activatable, and the activation or deactivation MAC-CEs may carry pointers to only those IEs. This allows the same type of MAC-CE to activate or deactivate an SCell by pointing to an secondary cell configuration top-level IE and including the SCell index, and to later on activate or deactivate a TCI state by pointing to a TCI state IE and including the TCI state index.

More particularly, in one or more aspects of the present disclosure, the same MAC-CE may perform different actions based on its configuration. For instance, at one time, the MAC-CE may activate or deactivate a cell, while at another time, it may activate or deactivate a TCI state. The behavior changes based on how the MAC-CE is reconfigured, providing a versatile and dynamic control mechanism. Similarly, in one or more aspects of the present disclosure, MAC-CEs may be defined specifically for activation and deactivation, rather than merely for updating a value. These MAC-CEs may for example have a one-bit or two-bit field indicating whether to activate, deactivate, or toggle the activation state of a pointer-indicated variable or parameter, with the number of bits in the field depending on which activation state(s) are available. While the aforementioned approach may be helpful for functionalities that can be activated or deactivated, it may not be useful for parameters that are simply indices and which cannot be deactivated, such as a PDCCH beam index. Therefore, in one or more aspects of the present disclosure, the RRC definition may specify which IEs are activatable, for example in an enumerated data structure 511 of activatable configuration parameters that may be referenced in a flexible MAC-CE. Flexible MAC-CEs may then reference these activatable IEs and perform corresponding actions. This allows for only appropriate parameters to be subject to activation and deactivation.

In one or more aspects of the present disclosure, multiple field updates in a single MAC-CE may be managed efficiently. For example, instead of using multiple separate flexible MAC-CEs to update different parameters via the pointer mechanism of FIG. 5, a single MAC-CE may indicate multiple pointers 502 to RRC IEs 402 to be updated and the updated value for each of these IEs. Each individual IE updated by the same MAC-CE may have its own individual action times, providing precise control over when the updates take effect.

Managing typical MAC-CEs requires an understanding of their specification behavior, including the definition of fields, the behavior upon receipt, and the action time. These components are important for ensuring that MAC-CEs function correctly and efficiently within the network. In the current 5G specifications, the behaviors associated with the receipt of typical MAC-CEs are well-defined. For instance, uplink MAC-CEs typically do not have an action time, and many downlink MAC-CEs also lack this feature. However, some downlink MAC-CEs do have an action time based on a fixed time offset from the slot in which an acknowledgment (ACK) for the MAC-CE is transmitted. This offset may be specified in actual time, such as 3 milliseconds, or in slots, such as 3N slots, where N is a nominal number of slots per millisecond. This mechanism ensures that the action time is synchronized with the network's timing. 5G networks also support code block group (CBG)-based transmission, where separate acknowledgments are provided for each CBG of a transport block (TB), in addition to an acknowledgment for the entire TB. The acknowledgment referred to in the context of MAC-CEs is one indicating that all CBGs, that is the whole TB, have been received, although in some cases, an acknowledgment may be sent specifically for the CBG carrying the MAC-CE.

Thus, traditional MAC-CEs are rigidly implemented. The activation time is often tied to the ACK of the received MAC-CE. For instance, after receiving a MAC-CE on the downlink, the UE may send an ACK, and the update may take effect three milliseconds after the ACK is sent. Moreover, there can be separate ACKs for different parts of the packet received on the downlink, or CBGs. These CBGs may contain MAC-CEs, and the timing of the updates may be based on when the entire packet is acknowledged or when specific CBGs are acknowledged. Thus, it would be helpful for activation times for flexible MAC-CEs to be less rigidly configured.

In one or more aspects of the present disclosure, for flexible MAC-CEs using a pointer framework such as described with respect to FIG. 5, several action time approaches may be provided. In one approach, the MAC-CE may be associated with a fixed action time that is independent of which IE the MAC-CE is updating, activating, or deactivating. This approach simplifies implementation but may not provide the granularity needed for certain updates. Therefore, in another approach, the MAC-CE may be associated with a fixed but IE-dependent action time, where each IE has a separate activation time. This method allows for more precise control over the timing of updates, allowing for each IE to be updated at the optimal time. In a further approach, a variable action time may be included within the MAC-CE itself. In this case, the action time field's interpretation may depend on the IE being updated. This approach provides the highest level of flexibility, allowing the network to adapt to a wide range of scenarios and requirements. The action time here may be tailored to the specific needs of each IE, ensuring that updates are performed efficiently and effectively.

In one or more aspects of the present disclosure, flexible MAC-CEs may interact with regular or typical (non-flexible, 5G-style) MAC-CEs. Both types of MAC-CEs may be defined for updating the same IEs, but with slightly different functionalities besides the basic IE update. One example of such different functionality is the action time for a particular parameter. For instance, a regular MAC-CE may have a fixed action time, while a flexible MAC-CE may have a variable action time, providing more precise control over the update process. For example, if a regular MAC-CE dedicated for updating a beam index is received with a fixed, three-millisecond activation time to update that beam index, a flexible MAC-CE configured to update the same beam index using the pointer framework may be configured with a different activation time. This differentiation ensures that the network can manage updates efficiently, even when multiple types of MAC-CEs are involved.

One or more aspects of the present disclosure further apply to handling of uplink MAC-CEs in 5G networks. Unlike downlink MAC-CEs, where the base station controls the UE behavior, uplink MAC-CEs involve the UE requesting its preferences for certain parameters. For example, the UE may request the base station to configure specific values in an uplink MAC-CE, such as requesting to be configured with no more than ten carriers due to battery or processing limitations. In the case of flexible MAC-CEs, the same principles previously discussed for downlink MAC-CEs, where the base station commands or indicates specified values for certain IEs, here may be applied to uplink MAC-CEs, where the UE requests or indicates preferred values for how the base station may configure certain parameters.

Traditionally for MAC-CEs, in the downlink, the base station may send commands to set specific RRC parameters. In the uplink, the UE may send its preferences to the base station, indicating which values it requests for certain parameters. These preferences may be listed in decreasing order of priority, allowing the base station to choose the best configuration based on network conditions. For example, the UE may request to be configured with exactly five carriers, but it may also provide alternative preferences, such as seven carriers if five is not possible. This distinction between downlink MAC-CEs and uplink MAC-CEs arises from the different roles of the base station and the UE. The base station sends commands in MAC-CEs to the UE in the downlink, while the UE requests preferences in MAC-CEs in the uplink. On the downlink, only one parameter value is indicated for each parameter to be configured. In contrast, on the uplink, the UE may indicate multiple parameter values in order of decreasing preference. The number of values may be indicated separately for each parameter, providing the base station with a range of options to choose from based on network conditions and policies.

Thus, the base station response to uplink MAC-CEs in 5G networks is typically not tightly defined, offering flexibility in how the base station handles these messages. Many uplink MAC-CEs serve primarily as informational elements, conveying the UE's preferences or requests. For example, a buffer status report (BSR) MAC-CE requests an uplink grant, but it is ultimately up to the base station to decide how to respond. This contrasts with downlink MAC-CEs, which are often used to update specific RRC IEs at the UE, with the MAC-CE or DCI indicating which IE to update. In the context of UL MAC-CEs, there is no specific IE at the base station side to be updated because the base station is responsible for configuring the UE with updated IEs.

In one or more aspects of the present disclosure, flexible UL MAC-CEs may be applied as a generic mechanism to indicate the UE's preferred values for specific DL RRC-configured IEs using the pointer framework described with respect to FIG. 5. These one or more aspects may also be extended to UL RRC messages, UCI, or other control information, for example using the ‘IEpointer’ framework previously described. In the uplink context, the aforementioned pointer framework may allow for control information to refer to a specific DL RRC IE, without requiring creation of a new UL message format for each DL IE.

In one or more aspects of the present disclosure, the configuration and formatting for flexible UL MAC-CEs may be identical or similar to that of flexible DL MAC-CEs, with a difference being that the DL MAC-CE sets the RRC IE 402 at the UE, while the UL MAC-CE conveys the UE's preference for what the base station may set on the DL. Thus, downlink MAC-CEs and uplink MAC-CEs may have symmetrical formatting using the pointer framework previously described, simplifying implementation and providing consistency across different types of MAC-CEs.

In one or more aspects of the present disclosure, when the UE provides multiple preferences in an uplink MAC-CE, the UE may request configurations for multiple parameters, such as bandwidth and periodicity. The UE may list its preferences or preferred values for these parameters, which parameters may be referenced using pointers 502 according to any of the aspects previously described, and the base station may then configure the UE based on these preferences. For example, the UE may request a bandwidth of 100 MHz or 50 MHz in order of ascending or descending priority, and a periodicity of 80 ms or 40 ms in order of ascending or descending priority, with pointer references to these parameters. The base station may respond by indicating which preferred bandwidth and periodicity of the UE the base station has selected in a DL MAC-CE, similarly, referencing the parameters using pointers 502. The parameter update process may thus be both efficient and compact.

When the UE conveys preferences for multiple separate parameters such as previously described, these parameters may be coupled or inter-related. For example, rather than requesting bandwidth preferences or periodicity preferences individually and independently, the UE may request pairs of bandwidths and periodicities in order of ascending or descending priority. Therefore, in one or more aspects of the present disclosure, the UE may express preference priority across multiple sets of parameters rather than for individual parameters. This may be achieved, for example, by listing the IE pointers of the constituent IEs to be updated. For example, when requesting updates for two coupled parameters such as DL tracking reference signal (TRS) bandwidth in megahertz and periodicity in milliseconds, the UE may reference the DL TRS bandwidth and periodicity in the MAC-CE via pointers 502 and indicate the following pairs of values according to a priority ordering of: (100,80), (50,40), (50,80), (100,40). The UE may indicate these paired or otherwise coupled values, as opposed to for example separate priority indications for bandwidth (100,50) and periodicity (80,40), to correctly convey its preferred priority pairs.

In one or more aspects of the present disclosure, a corresponding flexible DL mechanism for expressing selected preferences may be defined, where the base station compactly indicates in its DL MAC-CE which of the UE's preference(s) are allowed. This indication may be achieved, for example, via indexing into the received UL MAC-CE. Thus, the flexible DL MAC-CE in these aspect(s) may be more compact than a typical DL MAC-CE. For example, in the aforementioned case where the UE references a DL TRS bandwidth and periodicity in an UL MAC-CE via pointers 502, the UE may provide the base station with the following pairs of values according to a priority ordering of: (100,80), (50,40), (50,80), (100,40). In response, the base station may provide a DL MAC-CE indicating pointers 502 to the bandwidth and periodicity as previously described, but instead of explicitly indicating selected values of 100 MHz and 80 ms for the parameters, the base station may indicate an index of ‘0’ to point to the (100, 80) indicated in the UL MAC CE. Alternatively or additionally, in response to an UL MAC-CE that indicates multiple parameters with a single value requested for each of them, such as 100 MHz for a DL TRS bandwidth and 80 ms for a periodicity, the base station may grant these multiple requests in a DL MAC-CE in a compact manner. For example, rather than inefficiently providing a DL MAC-CE that identically indicates granted values of 100 MHz for the bandwidth and 80 ms for the periodicity, the DL MAC-CE may simply include a bit indicating the UE's requested values have been granted for those parameters.

In one or more aspects of the present disclosure, flexible MAC-CEs and DCIs may include a security mechanism extended from RRC messages. RRC messages are generally highly secure because their security is established in the initial stages of wireless communication, allowing all subsequent RRC messages to be encrypted. This security characteristic of RRC messages may be leveraged to enhance the security of flexible MAC-CEs and DCIs through one or more approaches.

In one or more aspects of the present disclosure, an encryption scheme may be applied for flexible MAC-CEs, DCIs, or other control information. In one example, a mapping between IEpointer fields and the IEs they point to in the RRC configuration 504 may be randomized using a security key 512 exchanged during the RRC configuration. For instance, referring to the example of FIG. 5, instead of directly indicating in a MAC-CE that the pointer (#10) corresponds to a specific IE named ‘slots4’ in the higher level parameter of CSI resource periodicity and offset such as previously described, in this example the MAC-CE or other message may indicate a different, encrypted unique identifier such as #351 which may be mapped to #10 using security key 512 in an encrypted table. This approach allows the flexible MAC-CE or DCI to benefit from the robust security framework of RRC messages. Alternatively or additionally, in one or more aspects of the present disclosure, other security approaches may be adopted to provide enhanced security for these MAC-CEs or other control information. For example, security frameworks applying to other MAC-CEs that do not indicate pointers, such as to regular non-flexible MAC-CEs, may be applied to flexible MAC-CEs to enhance security of these control messages in general.

In one or more aspects of the present disclosure, any of the previously-described aspects of the present disclosure, including those relating to the framework of flexible MAC-CEs or other flexible control information, may be applied to 5G and subsequent wireless communication networks. The flexibility and security of MAC-CEs and DCIs may be enhanced, such as using the pointer framework shown in FIG. 5, with respect to typical RRC and ASN.1 frameworks such as illustrated in FIG. 4. These flexible MAC-CEs, DCIs, or other control information may be integrated into 5G wireless communications, 6G wireless communications, or other generations of wireless communication.

In one or more aspects of the present disclosure, any of the aforementioned aspects may be applied only to IEs 402 defined in subsequent 5G releases, providing for gradual introduction of flexible MAC-CEs without disruptions to existing frameworks. For example, if another parameter or IE 402 is subsequently added to the RRC configuration 504 of FIG. 4 in a subsequent release, this added parameter or IE may be assigned with a pointer such as shown in FIG. 5, while the remaining parameters may remain without pointers 502 as shown in FIG. 4.

In one or more aspects of the present disclosure, any of the aforementioned aspects may be applied to IEs 402 of current and subsequent releases, such as Release 15, 16, 17, and so forth. For instance, all of the parameters shown in FIG. 4 may be assigned with pointers 502 as shown in FIG. 5. However, these pointers may be interpreted specifically by UEs with a declared capability for this pointer framework, rather than by UEs in general. For example, a UE that receives the RRC configuration 504 of FIG. 5 with flexible MAC-CE capability may map pointers 502 to tokens 506 as shown, while a UE that lacks this flexible MAC-CE capability may disregard the pointers 502.

In one or more aspects of the present disclosure, any of the aforementioned aspects may be applied only for certain protocols or ASN.1 modules. For instance, the RRC configuration of FIG. 4 may be provided without pointers 502 for RRC IEs 402, while a configuration similar to FIG. 5 including pointers 502 may be provided for SLPP or LPP IEs.

In one or more aspects of the present disclosure, RRC parameters to be updated in a flexible MAC-CE may not be identified by a pointer index such as shown in FIG. 5, but by explicit enumeration. For instance, the RRC configuration of FIG. 5 may include a list or data structure 514 of fields that may be updated in a flexible MAC-CE by reference to their index or element in the enumerated list, rather than via assigned pointers to each parameter as illustrated.

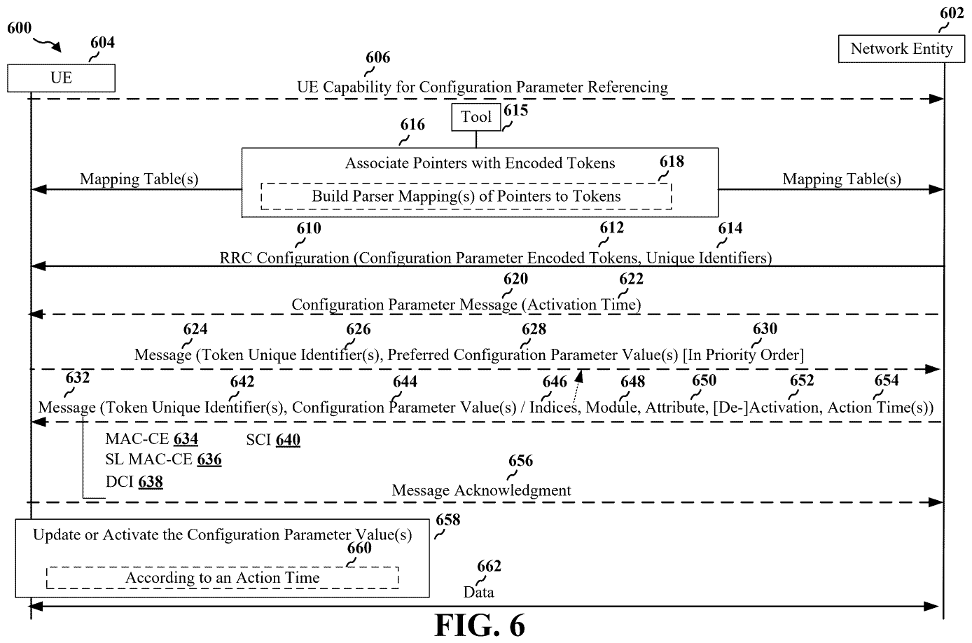

FIG. 6 illustrates an example 600 of a call flow between a network entity 602 and a UE 604. The network entity 602 may correspond to base station 102/180, disaggregated base station 181, a component of disaggregated base station 181 such as CU 183, DU 185, or RU 187, UE 104, or other network entity. In this example 600, a communication process between the network entity 602 and UE 604 is depicted, illustrating the configuration and dynamic updating of parameters using flexible MAC-CEs, DCIs, or other control messages using the aforementioned pointer mechanism according to one or more aspects of the present disclosure. While the illustrated example specifically shows a communication flow between a network entity and a UE, it should be understood that this call flow may extend to other combinations of communication devices over a wireless or wired link, including between UEs in sidelink communication or generally between communication devices under a signaling protocol.

Initially, unique identifiers may be assigned to RRC encoded tokens in an RRC configuration based on one or more rules. The unique identifiers may correspond, for example, to pointers 502 in FIG. 5, while the RRC encoded tokens may correspond, for example, to tokens 506 of FIG. 5. In various examples, the assignment of unique identifiers to tokens may occur in one or more specifications of RRC IEs 402, prior to communication of RRC messages or configurations between the UE 604 and network entity 602. In some examples, the assignment of unique identifiers to tokens may occur at UE 604 and network entity 602 in response to communication of RRC messages including a list or data structure 514 of updatable fields in one or more specifications of RRC IEs 402. In various examples, the unique identifiers may be assigned explicitly such as illustrated in FIG. 5. For example, pointers may be assigned to tokens sequentially, so that tokens such as ‘slots10’ in FIG. 5 are uniquely identified by a number or other identifier such as #13. Alternatively or additionally, the unique identifiers may be assigned implicitly based on alphabetical order or other rule(s). For example, the tokens may be organized alphabetically and pointers may be assigned accordingly without explicitly indicating pointers in the RRC configuration. Either approach allows the network to dynamically reference different IEs within RRC messages, facilitating efficient updates.

Following an external assignment of pointers to tokens in the specification(s), the UE may transmit a message indicating a UE capability 606 for configuration parameter referencing. For example, the UE capability 606 may indicate support for the flexible lower layer control framework, allowing the UE to dynamically update parameters using the pointer mechanism described according to one or more aspects of the present disclosure. More particularly, this capability allows the UE to efficiently interpret and apply updates by referencing parameters through unique identifiers, such as illustrated in FIG. 5. In FIG. 5, each parameter is assigned a unique pointer, allowing the UE to map these pointers to specific configuration parameters, facilitating streamlined updates without the need for new MAC-CE definitions. In one example, the UE capability 606 may be a coarse level capability indicating whether or not the UE may interpret and apply updates to the pointers in general. In another example, the UE capability 606 may be a fine level capability indicating whether or not the UE may interpret and apply updates to a subset of these pointers, such as pointers in one or more families or other groups of pointers. These families may include, for example, pointers in a given specification, a given ASN.1 module, explicitly enumerated pointers or elements in a family, or other groups of pointers. In a further example, the UE capability 606 may include a combination of the aforementioned coarse and fine capabilities.

Using such capabilities indicated in UE capability 606, for example, the UE may manage dynamic updating of a potentially large number of parameters and state variables, without requiring reliance on updates from a well specified procedure such as MAC procedures for various MAC timers or from slower, higher-layer signaling such as RRC messaging. However, such dynamic updates, if not carefully managed by the configuring entity, may have the potential for placing the UE into an erroneous configuration state. Thus, in one or more aspects of the present disclosure, a default or reset state may be defined, in which the UE may reset all its configuration and state variables whenever such an erroneous state configuration is detected. Detection may occur at either or both communication devices in the link, such as at the network or base station or UE, and may be reported over the link from one communication device to the other communication device. A reset may be triggered by the network or automatically initiated by the UE. The default configuration may be explicitly signaled, for example, at RRC connection setup time, or may be implicitly signaled, for example, via the configuration into which the UE was initialized at RRC connection setup, or via some other, specific configuration that is indicated to be utilized for the default or reset configuration. The specific configuration may be indicated explicitly using one or more lists of configuration parameters and their corresponding value(s), or implicitly via a command that indicates that a current UE configuration is to be saved as a default configuration.

An external tool 615, such as an application of a controller or processor in another device separate from the UE 604 and network entity 602, at block 616 may associate assigned unique identifiers or pointers with the encoded tokens or variable names. This association of unique identifiers to tokens may occur, for example, at the external tool's ASN.1 automated parser or core module, prior to communication of RRC messages including these tokens. For instance, at block 618, tool 615 external to the UE and network entity respectively may build one, or in some cases multiple depending on the data type 406, parser mapping(s) or mapping table(s) of the pointers with the tokens. For example, the external tool 615 to the UE or network entity may create a mapping table where each pointer, such as #13, is linked to its corresponding token, such as ‘slots10’, as shown in FIG. 5. The external tool 615 may then provide these mapping table(s) to the UE 604 and network entity 602 for use, for example, when loading software code into the UE and network entity. This mapping allows the UE and network entity to efficiently reference and update the parameters by using the pointers to identify the specific configuration elements within RRC configurations. In some cases, the association may occur in response to the UE 604 indicating UE capability 606 for configuration parameter referencing. The another device including this tool that performs the association may be for example, another UE or network entity.

The network entity may transmit an RRC configuration 610 to the UE. The RRC configuration 610 may correspond, for example, to RRC configuration 504 of FIG. 5, including RRC IEs 402 as configuration parameters. The RRC configuration 610 may include configuration parameter encoded tokens 612 explicitly or implicitly assigned to unique identifiers 614 or pointers. The encoded tokens 612 may correspond, for example, to tokens 506 of FIG. 5, representing the variable names of the RRC IEs 402 or configuration parameters. For example, the RRC configuration may include tokens such as ‘slots10’ and the like as illustrated in FIG. 5, defining specific parameters within the network. The RRC configuration 610 may in some examples include the unique identifiers 614 associated with one or more of the encoded tokens 612. The unique identifiers 614 may correspond, for example, to pointers 502 in FIG. 5. For example, the RRC configuration may include pointers such as #13 for ‘slots10’ illustrated in FIG. 5, which pointers allow the network entity and UE to reference specific parameters for identification and update.

The network entity may transmit a configuration parameter message 620, such as a regular, non-flexible MAC-CE or DCI, to the UE. For example, this message may specify updates to parameters such as ‘slots10’ in FIG. 4, but using predefined formats to convey updates without the flexibility of dynamic pointer referencing. In some examples, the message 620 may indicate or be associated with an activation time 622 or action time for one or more of the RRC IEs 402 in the RRC configuration 610. For example, the activation time may specify when an update to a parameter such as ‘slots10’ in FIG. 4 is to take effect, ensuring that changes occur within a defined timeframe.

The UE may transmit a message 624, such as an uplink flexible MAC-CE, SL MAC-CE, UCI, SCI, or other control information, to the network entity. In some examples, the message 624 may indicate one or more token unique identifier(s) 626 pointing to respective configuration parameters or RRC IEs 402 in the RRC configuration 610 to preferably be updated. Token unique identifiers 626 may correspond, for example, to pointers 502 in FIG. 5. For example, the UE may indicate a pointer such as #13 to specify that the ‘slots10’ parameter in FIG. 5 is requested to be updated, allowing the network entity to identify the exact configuration element to be modified. In some examples, the message 624 may indicate one or more preferred configuration parameter value(s) 628 according to a given priority order 630 for updating the configuration parameters or RRC IEs 402 associated with the token unique identifier(s) 626. For example, the UE may specify preferred values for ‘slots10’ in FIG. 5 in a prioritized list following a descending or ascending order, while using the pointer #13 to reference the parameter. This allows the network entity to ascertain the UE's preferences and update the configuration accordingly.

The UE may receive a message 632, such as a downlink flexible MAC-CE 634, SL MAC-CE 636, DCI 638, SCI 640, or other control information, from the network entity. In some examples, the message 632 may be in response to message 624, such as a DL flexible MAC-CE granting requests in an UL flexible MAC-CE, while in other examples, the message 632 may be received without any transmission of message 624. In some examples, the message 632 may indicate one or more token unique identifier(s) 642 pointing to respective configuration parameters or RRC IEs 402 in the RRC configuration 610 to be updated. Token unique identifiers 642 may correspond, for example, to pointers 502 in FIG. 5. For example, the message may indicate a pointer such as #13 to specify updates to the ‘slots10’ parameter shown in FIG. 5. In some examples, the message 632 may indicate one or more configuration parameter value(s) 644 for updating the configuration parameters or RRC IEs 402 associated with the token unique identifier(s) 642. For example, the message may specify an updated value for ‘slots10’, while using the pointer #13 to identify the parameter as illustrated in FIG. 5. In some examples where message 632 is in response to message 624, the message 632 may compactly include one or more configuration parameter indices 646 referencing the which one or more of the one or more preferred configuration parameter value(s) 628 in message 624 have been granted for updates. For example, the message may indicate that a preferred value of the UE for ‘slots10’ has been accepted, while using the pointer #13 to reference the parameter as shown in FIG. 5. In some examples, the message 632 may indicate one or more protocols or modules 648 associated with the token unique identifier(s) 642, such as RRC, LPP, SLPP, or the like. For example, the message may specify that the update pertains to an RRC module, while using pointers associated with the RRC module to identify the relevant parameters. In some examples, the message 632 may indicate one or more attributes 650 associated with the token unique identifier(s) 642, such as for downlink or uplink, or the like. For example, the message may specify that the ‘slots10’ parameter is for downlink, while using pointers specifically associated with downlink messages. In some examples, the message 632 may indicate an activation state 652 or deactivation state for the configuration parameter associated with the token unique identifier(s) 642, such as activated, deactivated, dormant, toggle state, or the like. In some examples, the message 632 may indicate an action time 654 for updating or activating the configuration parameter associated with the token unique identifier(s) 642, which action time 654 may be fixed, fixed but parameter-dependent, or variable. The UE may then transmit an acknowledgment 656 in response to the message 632, which acknowledgment 656 may be sent after a time period given by a unit of time or slots, and which acknowledgment 656 may be in response to a given CBG containing message 632 or an entire transport block including message 632.

After receiving the message 632, the UE at block 658 may update or activate the configuration parameter value(s) 644 indicated via token unique identifier(s) 642 in the message 632. For instance, the UE may perform a value update or an activation update according to an action time 660 given by action time 654. The value update may include, for example, a change in configuration parameter value(s) 644. The activation update may include, for example, an activation, deactivation, or toggling of a prior activation state of configuration parameter value(s) 644. After the value update or activation update occurs for the pointer-referenced parameters, the UE and network entity may communicate data 662 on the downlink or uplink using the value updated or activation updated values. For instance, the network entity may transmit data using a different PDCCH beam index, a DRX functionality may be enabled or disabled, or the like.

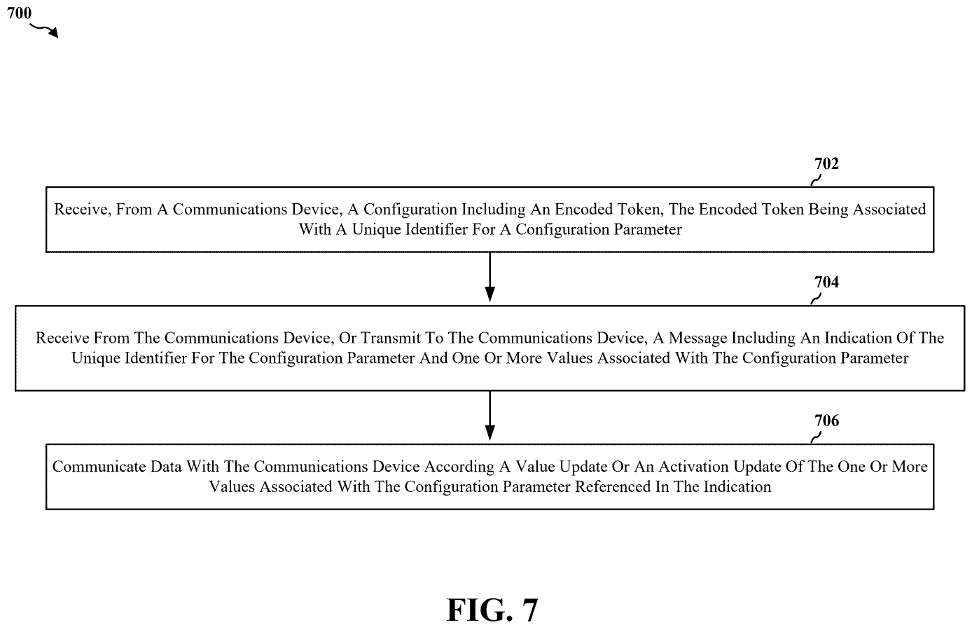

FIG. 7 is a flowchart 700 of a method of wireless communication. The method may be performed by a first communications device such as a UE or one or more of its components, for example, the UE 104, 604; communications device 350; one or more of RX processor(s) 356, TX processor(s) 368, or controller(s)/processor(s) 359; the apparatus 902; or cellular baseband processor(s) 904 or its components. The method allows a first communications device such as a UE to efficiently manage and update configuration parameters using unique identifiers, facilitating dynamic communication with a second communications device such as a network entity. While the method refers to the first communications device as a UE and the second communications device as a network entity in one example, it should be understood that the method of FIG. 7 may be extended to other communication devices. For instance, the first communications device and the second communications device may both be UEs or respectively be other communications devices in a wireless or wired link in other examples.

At block 702, the first communications device may receive, from a second communications device such as a network entity, a configuration including an encoded token, the encoded token being associated with a unique identifier for a configuration parameter. For example, block 702 may be performed by configuration component 940. Receiving the configuration may include, for example, receiving, demodulating, and decoding an encoded and modulated signal including the configuration using one or more of RX processor(s) 356 or controller(s)/processor(s) 359 such as described with respect to communications device 350 in FIG. 3. For instance, referring to the Figures, the base station 102/180 or network entity 602 may send, and UE 104, 604 may obtain, RRC configuration 610 including encoded tokens 612 for RRC IEs 402 and associated with unique identifiers 614. Encoded tokens 612 may be tokens 506 that are ASN.1 encoded, for example. Unique identifiers 614 may correspond to pointers 502, for example. Configuration parameters may correspond to RRC IEs 402, for example.

At block 704, the first communications device may receive from the second communications device, or transmit to the second communications device, a message including an indication of the unique identifier for the configuration parameter and one or more values associated with the configuration parameter. For example, block 704 may be performed by message component 942. Receiving the message may include, for example, receiving, demodulating, and decoding an encoded and modulated signal including the message using one or more of RX processor(s) 356 or controller(s)/processor(s) 359 such as described with respect to communications device 350 in FIG. 3. Transmitting the message may include, for example, encoding, modulating, and transmitting the message using one or more of TX processor(s) 368 or controller(s)/processor(s) 359 such as described with respect to communications device 350 in FIG. 3. For instance, referring to the Figures, the base station 102/180 or network entity 602 may send, and UE 104, 604 may obtain, message 632 on the downlink or message 624 on the uplink. Message 624, 632 may be, for example, a flexible MAC-CE. Message 624, 632 may indicate unique identifier(s) 626, 642 for the RRC IEs 402 in RRC configuration 610, along with parameter value(s) 628, 644 associated with these RRC IEs 402. Thus, message 624, 632 may reference configuration parameters using pointers 502 and include values for the network entity to use to update the referenced parameters.

At block 706, the first communications device may communicate data with the second communications device according to a value update or an activation update of the one or more values associated with the configuration parameter referenced in the indication. For example, block 706 may be performed by data component 944. Communicating the data may include, for example, receiving, demodulating, and decoding an encoded and modulated signal including the data using one or more of RX processor(s) 356 or controller(s)/processor(s) 359 such as described with respect to communications device 350 in FIG. 3. Alternatively or additionally, communicating the data may include, for example, encoding, modulating, and transmitting the data using one or more of TX processor(s) 368 or controller(s)/processor(s) 359 such as described with respect to communications device 350 in FIG. 3. For instance, referring to the Figures, the base station 102/180 or network entity 602 may send, and UE 104, 604 may obtain, or the base station 102/180 or network entity 602 may obtain and UE 104, 604 may send, data 662 according to a value update or activation update at block 658 of the parameter value(s) 628, 644 associated with the RRC IEs 402 referenced by their tokens 612 using unique identifiers 626, 642 in message 624, 632. For example, after an SCell is activated, a PDCCH beam index is changed, a DRX functionality is activated, or some other update, activation, deactivation, or activation state toggle occurs based on or for the parameter value(s) indicated in the prior message, the UE and network entity may communicate with each other using this value updated or activated, deactivated, or otherwise activation updated configuration parameter.

In one example, the message is a RRC message, a medium access control (MAC) control element (MAC-CE), a sidelink MAC-CE, downlink control information (DCI), uplink control information (UCI), or sidelink control information (SCI), and the indication of the unique identifier for the configuration parameter is included in a field of the message. For instance, message 624, 632 may be either a MAC-CE 634, SL MAC-CE 636, DCI 638, UCI, or SCI 640 which includes a field indicating the unique identifier(s) 642 to the UE or network entity. Alternatively, message 624, 632 may be an RRC message. For example, the token indices may be used in configuration messages such as RRC, in addition to lower-layer messages such as MAC-CE or DCI. One example of such usage in RRC messages may be where the behavior of the flexible MAC-CE or DCI is configured via the RRC message indicating the token index.

In one example, the encoded token is an abstract syntax notation one (ASN.1) encoded token corresponding to a single field or a sub-field of a structure or of a nested structure or corresponding to a MAC layer defined variable or a physical layer defined variable in the structure or the nested structure, and the encoded token is a variable name, a variable data type, or a variable name associated with a common variable data type. For instance, encoded token(s) 612 may be delimited with markers 404 of ASN.1 encoding such as shown in FIG. 5, and each token may correspond to a single field such as slots10 in FIG. 5, a sub-field of a structure such as slots10 of CSI-ResourcePeriodicityAndOffset in FIG. 5 or of a nested structure such as ZP-CSI-RS-Resource in FIG. 5. Each token may be a variable name such as ‘slots10’, a variable data type such as ‘integer’, or a variable name associated with a common variable data type such as ‘CSI-ResourcePeriodicityAndOffset’ which is a sufficiently simple derived structure with only integer members. Alternatively, a separate listing or table of all the tokens and their mapped pointers may be maintained in a specification document, for example, in an appendix of the document in which the tokens are defined. In this data structure, the tokens may be listed, including a partial or complete hierarchy of their parent or ancestor IEs within which the tokens occur, so as to be able to distinguish identical token names within different parent IEs. This list or another such data structure may also include pointers assigned to other state variable names that occur in the specifications, but not within ASN.1 IEs, such as RRC messages, including for example, RRC or MAC counters, such as N310, timers, such as DRXInactivityTimer, or the whole MAC state itself. In the foregoing, ASN.1 encoding is referenced because many 3GPP protocol messages such as RRC use ASN.1 encoding; however the aforementioned approaches described throughout this disclosure may equally apply to other encoding schemes or languages, for example, Transfer Syntax Notation One (TSN.1), Concrete Syntax Notation One (CSN.1), data serialization formats such as JavaScript Object Notation (JSON), Python Pickle, Extensible Markup Language (XML), or other notation schemes.

In one example, the unique identifier may include a next available index following a previous count of unique identifiers respectively for different configuration parameters, the previous count including a total of at least one group of configuration parameters. For example, if a group of configuration parameters including the RRC IEs 402 in FIG. 5 have a total count of 3400 parameters, the unique identifier 626, 642 for a subsequently defined parameter may be assigned a next available pointer #3401 for configuration parameter referencing. In one example, the configuration includes an assigned correspondence of encoded tokens with unique identifiers across different specified sets of configuration parameters or separately for the different specified sets of configuration parameters. For example, RRC configuration 610 may include encoded tokens 612 assigned to unique identifiers 614 that are within a set of pointers across multiple sets of configuration parameters, such that for example the aforementioned total count of 3400 parameters encompasses IEs in multiple specification documents, or for individual specified sets of configuration parameters, such that for example the aforementioned total count of 3400 encompasses IEs within a single specification document.

In one example, the configuration includes a plurality of encoded tokens, and each of at least a subset of the encoded tokens is associated with a different unique identifier for a respective configuration parameter. For example, RRC configuration 610 may include encoded tokens 612 such as tokens 506 in FIG. 5, with each token 506 being associated with a different unique identifier or pointer 502 such a #1, #2, #3 and the like for respective RRC IEs 402.

In one example, the configuration includes an assigned correspondence of the encoded token with the unique identifier, and the association includes a parser built mapping of the unique identifier to the configuration parameter. For example, the encoded tokens 612 may be assigned with unique identifiers 614 in one or more specifications before being communicated in RRC configuration 610, and external tool 615 to the UE and network entity at block 616, 618 may include an ASN.1 encoding parser that builds a mapping table or array of pointers associating unique identifiers 614 to encoded tokens 612 corresponding to RRC IEs 402.

In one example, the configuration may include a plurality of encoded tokens, and each of a subset of the encoded tokens for a common data type is associated with a different unique identifier for a respective configuration parameter. For example, unique identifiers 614 may be assigned and associated with encoded tokens 612 corresponding to RRC IEs 402 including integers or otherwise of sufficiently simple derived types, such as the slot configurations within CSI-ResourcePeriodicityAndOffset in FIG. 5.

In one example, in response to the encoded token associated with the unique identifier for the configuration parameter corresponding to a field of a complex data type, the association includes a first parser built mapping of the unique identifier to the configuration parameter and a second parser built mapping of a primitive data type corresponding to the encoded token to the configuration parameter. For example, for encoded tokens 612 corresponding to RRC IEs 402 of a structure or nested structure, such as the IE ZP-CSI-RS-Resource in FIG. 5, unique identifiers 614 may be assigned and associated with these IEs 402 using multiple mappings such as a pointer array and a data type array. For instance, the external tool 615 at block 616, 618 may include an ASN.1 encoding parser that builds a first mapping table or array of pointers corresponding unique identifiers 614 to encoded tokens 612 corresponding to the structure's or nested structure RRC IEs 402, and a second mapping table indicating the data types 406 or other contextual information for these encoded tokens 612 to assist the UE and network entity in parsing the information. Data types 406 may be primitive data types such as integer, float, double, or the like.

In one example, the configuration includes a plurality of encoded tokens corresponding to different fields of a complex data type, and in response to each of the encoded tokens being for a primitive data type within the complex data type, each of the encoded tokens is associated with a different unique identifier for configuration parameter referencing. For example, for encoded tokens 612 corresponding to RRC IEs 402 of a structure such as the IE CSI-ResourcePeriodicityAndOffset in FIG. 5, where each of these RRC IEs are sufficiently simple derived types or have a same primitive data type such as integer within this structure, unique identifiers 614 may be assigned and associated with these IEs 402 for configuration parameter referencing.

In one example, the unique identifier may indicate a data type corresponding to the encoded token, and the message includes a quantity of bits for indicating the unique identifier with the data type. For example, unique identifier(s) 626, 642 may indicate data type(s) 406 for the encoded token(s) 612 configured in RRC configuration 610, such as “int1” for an integer variable with pointer (#1) or “char2” for a character variable with pointer (#2), and message 624, 632 may include one number of bits for indicating the pointer 502 such as #1 or #2, and another number of bits for indicating the data type 406 such as “int” or “char”.

In one example, the message may be the configuration, and the indication of the unique identifier for the configuration parameter may be configured in another encoded token of the configuration. For instance, message 632 may correspond to RRC configuration 610 including IE pointer field 508, which token 506 may indicate the pointer 502 for an associated RRC IE 402.

In one example, the configuration may include an assigned correspondence of encoded tokens with unique identifiers separately for different configuration parameters associated with a common attribute, and the message may indicate the common attribute corresponding to the encoded token. The common attribute may include at least one of: a module associated with the configuration parameter, a data type corresponding to the encoded token, a medium access control (MAC) control element (MAC-CE) or a downlink control information (DCI) configured to update the configuration parameter, an update behavior associated with the configuration parameter, a UE capability for an update of the configuration parameter, a downlink association or an uplink association with the configuration parameter, or an indication of a release associated with the unique identifier for the configuration parameter. These common attribute examples may refer to different criteria or families described with respect to explicit family partitioning. For instance, the external tool 615 may associate at block 616, encoded tokens 612 with unique identifiers 614 separately for different modules 648 such as an RRC module, LPP module, SLPP module, or the like. For example, the pointer (#10) may be uniquely assigned to one parameter in the RRC module, uniquely assigned to another parameter in the LPP module, and the like. In such case, message 632 may indicate the module 648 corresponding to the unique identifier 642 associated with its encoded token 612. More generally, in another example, the external tool 615 may associate at block 616, encoded tokens 612 with unique identifiers 614 separately for RRC IEs 402 having different attributes 650 such as modules 648, downlink, uplink, or the like. For example, the pointer (#10) may be uniquely assigned to one downlink parameter in RRC configuration 504, and uniquely assigned to one uplink parameter in RRC configuration 504. In such case, message 632 may indicate the attribute 650 corresponding to the unique identifier 642 associated with its encoded token 612.

In one example, the configuration may include an assigned correspondence of the encoded token with the unique identifier according to one or more rules, and the association includes a parser built mapping of the unique identifier to the configuration parameter. For example, encoded tokens 612 may be assigned with unique identifiers 614 implicitly according to an alphabetical order of the RRC IEs 402 or otherwise in accordance with other rule(s), and the external tool 615 at block 616, 618 may include an ASN.1 encoding parser that builds a mapping table or array of pointers associating unique identifiers 614 to encoded tokens 612 corresponding to RRC IEs 402 based on these rule(s).

In one example, the message may indicate to perform the value update or the activation update of the one or more values associated with the configuration parameter referenced in the indication following an action time. For example, message 632 may indicate the UE at block 658 to update, activate, deactivate, or toggle activation of the parameter value(s) 644 of the RRC IEs 402 referenced using unique identifier(s) 642 according to action time 654 or 660. For instance, the UE may update or activate the parameters according to the value(s) 644 after a period of time, number of slots, or the like indicated by action time 654, 660.

In one example, the configuration parameter may correspond to a field indicating an activation state for another parameter in the configuration, and the message may indicate the unique identifier and the one or more values for the field indicating the activation state. For example, message 632 may indicate the unique identifier 642 pointing to the field 510 in RRC configuration 610 representing the activation state for another RRC IE 402 in that RRC configuration. The field 510 may include one of multiple parameter value(s) 644, such as active, inactive, or dormant, for that other RRC IE in the RRC configuration.

In one example, the message may include a field dedicated for activation or deactivation of the configuration parameter in the configuration, and the configuration parameter may be from a data structure of a plurality of configuration parameters configured for activated configuration parameter referencing. For example, in addition to message 632 including unique identifier 642 pointing to an RRC IE 402 in RRC configuration 610, message 632 may include a separate field representing the activation state for that RRC IE 402 in the RRC configuration. The activation state may include one of multiple values such as activated, deactivated, or toggle state (from activated to deactivated or vice-versa) for that pointer-referenced RRC IE. The base station may reference this RRC IE 402 using pointer 502 in the message 632 in response to the RRC IE 402 being a configuration parameter that is activatable via message 632. For instance, the base station or UE may determine whether this RRC IE 402 is activatable in response to the RRC IE being enumerated within data structure 511 of activatable and referenceable configuration parameters in RRC configuration 504.

In one example, the message indicates a plurality of unique identifiers for different configuration parameters and one or more values respectively associated with the different configuration parameters, the different configuration parameters being respectively associated with different action times for the value update or the activation update. For instance, message 632 may indicate unique identifier(s) 642 along with parameter value(s) 644 to be updated or activated at block 658 respectively for different RRC IEs 402, where each of these RRC IEs 402 may be updated or activated at different action times 654, 660 corresponding to the respective IE. For example, one pointer-referenced IE may be configured to be updated or activated after one period of time, while a different pointer-referenced IE may be configured to be updated or activated after another period of time.

In one example, the message indicates a correspondence between an action time and the value update or the activation update of the configuration parameter, the action time is in a unit of time or quantity of slots, the value update or the activation update follows the action time, and the action time starts after an acknowledgement of a code block or a transport block including the message or a code block group including the message. For instance, message 632 may indicate to UE 604 that the RRC IE 402 referenced via unique identifier 642 is to be updated or activated following action time 654 or 660, which action time may be defined or configured to be a unit of time such as 3 ms or a quantity of slots such as 3N slots. This amount of time or amount of slots may be relative to or start from the time when the UE sends message acknowledgment 656 of message 632 to the base station, such as an ACK for MAC-CE 634. The acknowledgment 656 may be of a code block, CBG, or transport block including message 632.

In one example, the message may indicate to perform the value update or the activation update of the one or more values associated with the configuration parameter referenced in the indication following an action time, the action time being fixed for different configuration parameters, fixed specifically for the configuration parameter, or variably indicated in the message for the configuration parameter. For example, message 632 may indicate the UE at block 658 to update or activate the parameter value(s) 644 of the RRC IEs 402 referenced using unique identifier(s) 642 according to action time 654 or 660. For instance, the UE may update or activate the parameters according to the value(s) 644 after a period of time, number of slots, or the like indicated by action time 654, 660. This action time 654, 660 may be fixed across multiple RRC IEs 402, such as a same 3 ms for each RRC IE in RRC configuration 610. Alternatively, the action time 654, 660 may be fixed with a different value depending on the RRC IE 402, such as 3 ms for one parameter in RRC configuration 610 but 3N slots for another parameter in RRC configuration 610. Alternatively, the action time 654, 660 may be a variable value indicated in message 632 for the associated RRC IE 402, such as 3 ms, 4 ms, 3N slots, 4N slots, or any other value the base station dynamically sets as the action time for that RRC IE.

In one example, the message indicates a correspondence between an action time and the value update or the activation update of the configuration parameter, the action time being different than an activation time for a same configuration parameter configured in another message from the second communications device lacking configuration parameter referencing. For instance, message 632 may indicate to UE 604 that the RRC IE 402 referenced via unique identifier 642 is to be updated or activated following action time 654 or 660, which action time may be different than an activation time 622 for this same RRC IE configured in message 620. Message 620 may be, for example, a non-flexible MAC-CE lacking pointers 502. For example, the action time 654, 660 associated with message 632 may be independent of, as well as different than, the activation time 622 associated with message 620 for a same encoded token 612 corresponding to a given RRC IE.

In one example, the message is an uplink message including one or more preferred values for the configuration parameter, and the data communicated with the second communications device is according to the value update or the activation update of one or more selected values from the one or more preferred values in a subsequent downlink message to the uplink message. For instance, message 624 may be an uplink MAC-CE, UCI, or other uplink control message including preferred parameter value(s) 628 for an RRC IE 402, and the UE may communicate data 662 with the base station based on selected, parameter value(s) 644 provided in message 632. For example, if the UE indicates a preference for a TRS bandwidth and periodicity of 100 MHz and 80 ms as preferred value(s) 628 in message 624, the base station may select this bandwidth and periodicity as parameter value(s) 644 and subsequently in message 632 indicate the UE to update or activate the corresponding parameters using the selected, parameter value(s) 644. The UE and base station may then communicate data 662 using the updated parameter values accordingly.

In on example, the message is an uplink message including a plurality of preferred values respectively for different configuration parameters in an order of descending or ascending priority, the data communicated with the second communications device is according to the value update or the activation update of a selected value from the plurality of preferred values for each of the different configuration parameters in a subsequent downlink message to the uplink message, and the selected values are indicated in the subsequent downlink message via at least one respective index to the plurality of preferred values. For instance, message 624 may be an uplink MAC-CE, UCI, or other uplink control message including multiple preferred parameter values 628 for RRC IEs 402 listed in an ascending or descending order of priority, and the UE may communicate data 662 with the base station based on selected, parameter values 644 provided in message 632. For example, if the UE indicates a preference for TRS bandwidths and periodicities of (100 MHz, 80 ms) and (50 MHz, 40 ms) in descending order of priority as preferred values 628 in message 624, the base station may select one of these bandwidth and periodicity pairs as parameter values 644 and subsequently in message 632 indicate the UE to update or activate the corresponding parameters using the selected, parameter values 644. For compactness, the base station may indicate the selected bandwidth and periodicity pair or parameter values 644 via an index 646 pointing to the pair in message 624, rather than expressly indicate the parameter values again. The UE and base station may then communicate data 662 using the updated parameter values accordingly.

In one example, the unique identifier may be encrypted according to a key associated with the configuration, and the message may include the indication of the encrypted unique identifier. For instance, unique identifier(s) 642 in message 632 may be encrypted using encryption key 512, which key may be obtained during a configuration process of RRC configuration 610.

In some examples, the configuration includes a plurality of encoded tokens including the encoded token, and in response to an indicated UE capability, one of: a subset of the encoded tokens are configured for configuration parameter referencing, or the plurality of encoded tokens are configured for configuration parameter referencing in the message. For instance, encoded tokens 612 may be assigned with unique identifier(s) 614 for only those RRC IEs 402 in certain wireless generations such as those subsequent to 5G but not including 5G, or for RRC IEs including and subsequent to 5G, which pointers 502 may be indicated to UEs with capability 606 for such pointer referencing.

In some examples, the configuration parameter may be from a data structure of a plurality of configuration parameters configured for configuration parameter referencing and the unique identifier is an index to the data structure, or the configuration may include a plurality of encoded tokens including the encoded token, and a subset of the encoded tokens associated with one or more specified configuration parameter modules are configured for configuration parameter referencing. For instance, RRC IEs 402 explicitly listed in enumerated data structure 514 for pointer referencing may be assigned or associated with unique identifiers 614 corresponding to indices to this data structure 514. Alternatively or additionally, RRC configuration 504 including different modules 648 of RRC IEs 402 may include encoded tokens 612, where the encoded tokens 612 in one of these modules 648 are assigned to unique identifiers 614 for pointer referencing.

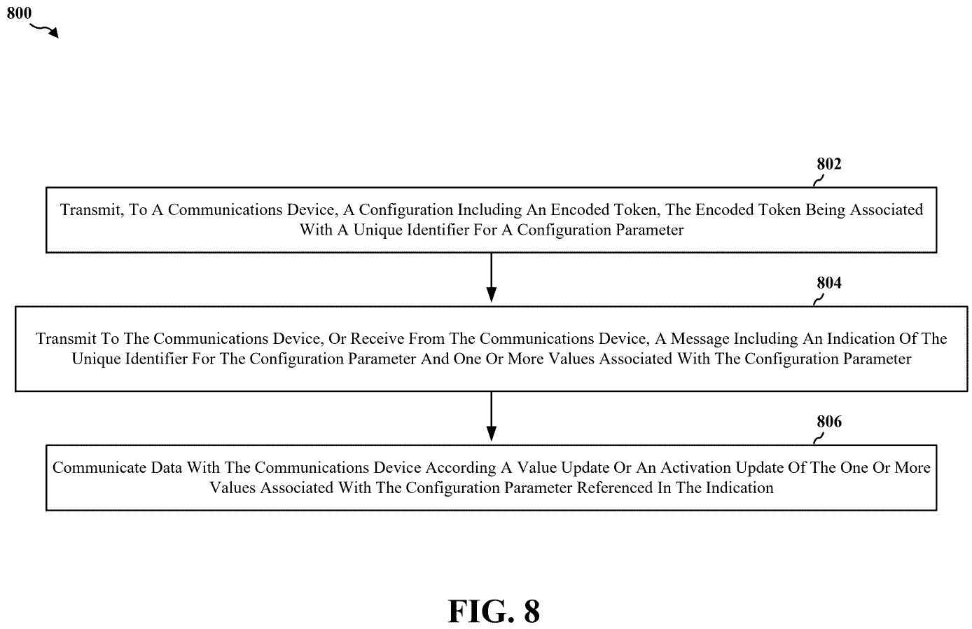

FIG. 8 is a flowchart 800 of a method of wireless communication. The method may be performed by a first communications device such as a network entity or a base station or one or more of its components, for example, the base station 102/180; network entity 602 communications device 310; disaggregated base station 181 or one or more of its components; one or more of RX processor(s) 370, TX processor(s) 316, or controller(s)/processor(s) 375; the apparatus 1002; or baseband unit(s) 1004 or its components. The method allows a first communications device such as a network entity to manage and update configuration parameters efficiently, enabling dynamic communication with a second communications device such as a user equipment. While the method refers to the first communications device as a network entity and the second communications device as a UE in one example, it should be understood that the method of FIG. 8 may be extended to other wireless communication devices. For instance, the first communications device and the second communications device may both be UEs or respectively be other communications devices in other examples.

At block 802, the first communications device may transmit, to a second communications device such as a UE, a configuration including an encoded token, the encoded token being associated with a unique identifier for a configuration parameter. For example, block 802 may be performed by configuration component 1040. Transmitting the configuration may include, for example, transmitting, modulating, and encoding the configuration using one or more of the TX processor(s) 316 or controller(s)/processor(s) 375, such as described with respect to communications device 310 in FIG. 3. For instance, referring to the Figures, the base station 102/180 or network entity 602 may send, and UE 104, 604 may obtain, RRC configuration 610 including encoded tokens 612 for RRC IEs 402 and associated with unique identifiers 614. Encoded tokens 612 may be tokens 506 that are ASN.1 encoded, for example. Unique identifiers 614 may correspond to pointers 502, for example. Configuration parameters may correspond to RRC IEs 402, for example.

At block 804, the first communications device may transmit to the second communications device, or receive from the second communications device, a message including an indication of the unique identifier for the configuration parameter and one or more values associated with the configuration parameter. For example, block 804 may be performed by message component 1042. Transmitting the message may include, for example, transmitting, modulating, and encoding the message using one or more of the TX processor(s) 316 or controller(s)/processor(s) 375, such as described with respect to communications device 310 in FIG. 3. Receiving the message may include, for example, receiving, demodulating, and decoding an encoded and modulated signal including the message using one or more of RX processor(s) 370 or controller(s)/processor(s) 375 such as described with respect to communications device 310 in FIG. 3. For instance, referring to the Figures, the base station 102/180 or network entity 602 may send, and UE 104, 604 may obtain, message 632 on the downlink or message 624 on the uplink. Message 624, 632 may be, for example, a flexible MAC-CE. Message 624, 632 may indicate unique identifier(s) 626, 642 for the RRC IEs 402 in RRC configuration 610, along with parameter value(s) 628, 644 associated with these RRC IEs 402. Thus, message 624, 632 may reference configuration parameters using pointers 502 and include values for the network entity to use to update the referenced parameters.

At block 806, the first communications device may communicate data with the second communications device according to a value update or an activation update of the one or more values associated with the configuration parameter referenced in the indication. For example, block 806 may be performed by data component 1044. Communicating the data may include, for example, transmitting, modulating, and encoding the data using one or more of the TX processor(s) 316 or controller(s)/processor(s) 375, such as described with respect to communications device 310 in FIG. 3. Alternatively or additionally, communicating the data may include, for example, receiving, demodulating, and decoding an encoded and modulated signal including the data using one or more of RX processor(s) 370 or controller(s)/processor(s) 375 such as described with respect to communications device 310 in FIG. 3. For instance, referring to the Figures, the base station 102/180 or network entity 602 may send, and UE 104, 604 may obtain, or the base station 102/180 or network entity 602 may obtain and UE 104, 604 may send, data 662 according to a value update or activation update at block 658 of the parameter value(s) 628, 644 associated with the RRC IEs 402 referenced by their tokens 612 using unique identifiers 626, 642 in message 624, 632. For example, after an SCell is activated, a PDCCH beam index is changed, a DRX functionality is activated, or some other value update or activation, deactivation, or activation state toggling occurs based on or for the parameter value(s) indicated in the prior message, the UE and network entity may communicate with each other using this value updated or activated, deactivated, or otherwise activation state updated configuration parameter.

In one example, the message is a RRC message, a medium access control (MAC) control element (MAC-CE), a sidelink MAC-CE, downlink control information (DCI), uplink control information (UCI), or sidelink control information (SCI), and the indication of the unique identifier for the configuration parameter is included in a field of the message. For instance, message 624, 632 may be either a MAC-CE 634, SL MAC-CE 636, DCI 638, UCI, or SCI 640 which includes a field indicating the unique identifier(s) 642 to the UE or network entity. Alternatively, message 624, 632 may be an RRC message. For example, the token indices may be used in configuration messages such as RRC, in addition to lower-layer messages such as MAC-CE or DCI. One example of such usage in RRC messages may be where the behavior of the flexible MAC-CE or DCI is configured via the RRC message indicating the token index.

In one example, the encoded token is an abstract syntax notation one (ASN.1) encoded token corresponding to a single field or a sub-field of a structure or of a nested structure or corresponding to a MAC layer defined variable or a physical layer defined variable in the structure or the nested structure, and the encoded token is a variable name, a variable data type, or a variable name associated with a common variable data type. For instance, encoded token(s) 612 may be delimited with markers 404 of ASN.1 encoding such as shown in FIG. 5, and each token may correspond to a single field such as slots10 in FIG. 5, a sub-field of a structure such as slots10 of CSI-ResourcePeriodicityAndOffset in FIG. 5 or of a nested structure such as ZP-CSI-RS-Resource in FIG. 5. Each token may be a variable name such as ‘slots10’, a variable data type such as ‘integer’, or a variable name associated with a common variable data type such as ‘CSI-ResourcePeriodicityAndOffset’ which is a sufficiently simple derived structure with only integer members. Alternatively, a separate listing or table of all the tokens and their mapped pointers may be maintained in a specification document, for example, in an appendix of the document in which the tokens are defined. In this data structure, the tokens may be listed, including a partial or complete hierarchy of their parent or ancestor IEs within which the tokens occur, so as to be able to distinguish identical token names within different parent IEs. This list or another such data structure may also include pointers assigned to other state variable names that occur in the specifications, but not within ASN.1 IEs, such as RRC messages, including for example, RRC or MAC counters, such as N310, timers, such as DRXInactivityTimer, or the whole MAC state itself.

In one example, the unique identifier may include a next available index following a previous count of unique identifiers respectively for different configuration parameters, the previous count including a total of at least one group of configuration parameters. For example, if a group of configuration parameters including the RRC IEs 402 in FIG. 5 have a total count of 3400 parameters, the unique identifier 626, 642 for a subsequently defined parameter may be assigned a next available pointer #3401 for configuration parameter referencing. In one example, the configuration includes an assigned correspondence of encoded tokens with unique identifiers across different specified sets of configuration parameters or separately for the different specified sets of configuration parameters. For example, RRC configuration 610 may include encoded tokens 612 assigned to unique identifiers 614 that are within a set of pointers across multiple sets of configuration parameters, such that for example the aforementioned total count of 3400 parameters encompasses IEs in multiple specification documents, or for individual specified sets of configuration parameters, such that for example the aforementioned total count of 3400 encompasses IEs within a single specification document.

In one example, the configuration includes a plurality of encoded tokens, and each of at least a subset of the encoded tokens is associated with a different unique identifier for a respective configuration parameter. For example, RRC configuration 610 may include encoded tokens 612 such as tokens 506 in FIG. 5, with each token 506 being associated with a different unique identifier or pointer 502 such a #1, #2, #3 and the like for respective RRC IEs 402.

In one example, the configuration includes an assigned correspondence of the encoded token with the unique identifier, and the association includes a parser built mapping of the unique identifier to the configuration parameter. For example, the encoded tokens 612 may be assigned with unique identifiers 614 in one or more specifications before being communicated in RRC configuration 610, and the external tool 615 at block 616, 618 may include an ASN.1 encoding parser that builds a mapping table or array of pointers associating unique identifiers 614 to encoded tokens 612 corresponding to RRC IEs 402.

In one example, the configuration may include a plurality of encoded tokens, and each of a subset of the encoded tokens for a common data type is associated with a different unique identifier for a respective configuration parameter. For example, unique identifiers 614 may be assigned and associated with encoded tokens 612 corresponding to RRC IEs 402 including integers or otherwise of sufficiently simple derived types, such as the slot configurations within CSI-ResourcePeriodicityAndOffset in FIG. 5.

In one example, in response to the encoded token associated with the unique identifier for the configuration parameter corresponding to a field of a complex data type, the association includes a first parser built mapping of the unique identifier to the configuration parameter and a second parser built mapping of a primitive data type corresponding to the encoded token to the configuration parameter. For example, for encoded tokens 612 corresponding to RRC IEs 402 of a structure or nested structure, such as the IE ZP-CSI-RS-Resource in FIG. 5, unique identifiers 614 may be assigned and associated with these IEs 402 using multiple mappings such as a pointer array and a data type array. For instance, the external tool 615 at block 616, 618 may include an ASN.1 encoding parser that builds a first mapping table or array of pointers corresponding unique identifiers 614 to encoded tokens 612 corresponding to the structure's or nested structure RRC IEs 402, and a second mapping table indicating the data types 406 or other contextual information for these encoded tokens 612 to assist the UE and network entity in parsing the information. Data types 406 may be primitive data types such as integer, float, double, or the like.

In one example, the configuration includes a plurality of encoded tokens corresponding to different fields of a complex data type, and in response to each of the encoded tokens being for a primitive data type within the complex data type, each of the encoded tokens is associated with a different unique identifier for configuration parameter referencing. For example, for encoded tokens 612 corresponding to RRC IEs 402 of a structure such as the IE CSI-ResourcePeriodicityAndOffset in FIG. 5, where each of these RRC IEs are sufficiently simple derived types or have a same primitive data type such as integer within this structure, unique identifiers 614 may be assigned and associated with these IEs 402 for configuration parameter referencing.

In one example, the unique identifier may indicate a data type corresponding to the encoded token, and the message includes a quantity of bits for indicating the unique identifier with the data type. For example, unique identifier(s) 626, 642 may indicate data type(s) 406 for the encoded token(s) 612 configured in RRC configuration 610, such as “int1” for an integer variable with pointer (#1) or “char2” for a character variable with pointer (#2), and message 624, 632 may include one number of bits for indicating the pointer 502 such as #1 or #2, and another number of bits for indicating the data type 406 such as “int” or “char”.

In one example, the message may be the configuration, and the indication of the unique identifier for the configuration parameter may be configured in another encoded token of the configuration. For instance, message 632 may correspond to RRC configuration 610 including IE pointer field 508, which token 506 may indicate the pointer 502 for an associated RRC IE 402.

In one example, the configuration may include an assigned correspondence of encoded tokens with unique identifiers separately for different configuration parameters associated with a common attribute, and the message may indicate the common attribute corresponding to the encoded token. The common attribute may include at least one of: a module associated with the configuration parameter, a data type corresponding to the encoded token, a medium access control (MAC) control element (MAC-CE) or a downlink control information (DCI) configured to update the configuration parameter, an update behavior associated with the configuration parameter, a UE capability for an update of the configuration parameter, a downlink association or an uplink association with the configuration parameter, or an indication of a release associated with the unique identifier for the configuration parameter. These common attribute examples may refer to different criteria or families described with respect to explicit family partitioning. For instance, the external tool 615 may associate at block 616, encoded tokens 612 with unique identifiers 614 separately for different modules 648 such as an RRC module, LPP module, SLPP module, or the like. For example, the pointer (#10) may be uniquely assigned to one parameter in the RRC module, uniquely assigned to another parameter in the LPP module, and the like. In such case, message 632 may indicate the module 648 corresponding to the unique identifier 642 associated with its encoded token 612. More generally, in another example, the external tool 615 may associate at block 616, encoded tokens 612 with unique identifiers 614 separately for RRC IEs 402 having different attributes 650 such as modules 648, downlink, uplink, or the like. For example, the pointer (#10) may be uniquely assigned to one downlink parameter in RRC configuration 504, and uniquely assigned to one uplink parameter in RRC configuration 504. In such case, message 632 may indicate the attribute 650 corresponding to the unique identifier 642 associated with its encoded token 612.

In one example, the configuration may include an assigned correspondence of the encoded token with the unique identifier according to one or more rules, and the association includes a parser built mapping of the unique identifier to the configuration parameter. For example, encoded tokens 612 may be assigned with unique identifiers 614 implicitly according to an alphabetical order of the RRC IEs 402 or otherwise in accordance with other rule(s), and the external tool 615 at block 616, 618 may include an ASN.1 encoding parser that builds a mapping table or array of pointers associating unique identifiers 614 to encoded tokens 612 corresponding to RRC IEs 402 based on these rule(s).

In one example, the message may indicate to perform the value update or the activation update of the one or more values associated with the configuration parameter referenced in the indication following an action time. For example, message 632 may indicate the UE at block 658 to update, activate, deactivate, or toggle the activation state of the parameter value(s) 644 of the RRC IEs 402 referenced using unique identifier(s) 642 according to action time 654 or 660. For instance, the UE may update or activate the parameters according to the value(s) 644 after a period of time, number of slots, or the like indicated by action time 654, 660.

In one example, the configuration parameter may correspond to a field indicating an activation state for another parameter in the configuration, and the message may indicate the unique identifier and the one or more values for the field indicating the activation state. For example, message 632 may indicate the unique identifier 642 pointing to the field 510 in RRC configuration 610 representing the activation state for another RRC IE 402 in that RRC configuration. The field 510 may include one of multiple parameter value(s) 644, such as active, inactive, or dormant, for that other RRC IE in the RRC configuration.

In one example, the message may include a field dedicated for activation or deactivation of the configuration parameter in the configuration, and the configuration parameter may be from a data structure of a plurality of configuration parameters configured for activated configuration parameter referencing. For example, in addition to message 632 including unique identifier 642 pointing to an RRC IE 402 in RRC configuration 610, message 632 may include a separate field representing the activation state for that RRC IE 402 in the RRC configuration. The activation state may include one of multiple values such as activated, deactivated, or toggle state (from activated to deactivated or vice-versa) for that pointer-referenced RRC IE. The base station may reference this RRC IE 402 using pointer 502 in the message 632 in response to the RRC IE 402 being a configuration parameter that is activatable via message 632. For instance, the base station or UE may determine whether this RRC IE 402 is activatable in response to the RRC IE being enumerated within data structure 511 of activatable and referenceable configuration parameters in RRC configuration 504.

In one example, the message indicates a plurality of unique identifiers for different configuration parameters and one or more values respectively associated with the different configuration parameters, the different configuration parameters being respectively associated with different action times for the value update or the activation update. For instance, message 632 may indicate unique identifier(s) 642 along with parameter value(s) 644 to be updated or activated at block 658 respectively for different RRC IEs 402, where each of these RRC IEs 402 may be updated or activated at different action times 654, 660 corresponding to the respective IE. For example, one pointer-referenced IE may be configured to be updated or activated after one period of time, while a different pointer-referenced IE may be configured to be updated or activated after another period of time.

In one example, the message indicates a correspondence between an action time and the value update or the activation update of the configuration parameter, the action time is in a unit of time or quantity of slots, the value update or the activation update follows the action time, and the action time starts after an acknowledgement of a code block or a transport block including the message or a code block group including the message. For instance, message 632 may indicate to UE 604 that the RRC IE 402 referenced via unique identifier 642 is to be updated or activated following action time 654 or 660, which action time may be defined or configured to be a unit of time such as 3 ms or a quantity of slots such as 3N slots. This amount of time or amount of slots may be relative to or start from the time when the UE sends message acknowledgment 656 of message 632 to the base station, such as an ACK for MAC-CE 634. The acknowledgment 656 may be of a code block, CBG, or transport block including message 632.

In one example, the message may indicate to perform the value update or the activation update of the one or more values associated with the configuration parameter referenced in the indication following an action time, the action time being fixed for different configuration parameters, fixed specifically for the configuration parameter, or variably indicated in the message for the configuration parameter. For example, message 632 may indicate the UE at block 658 to update or activate the parameter value(s) 644 of the RRC IEs 402 referenced using unique identifier(s) 642 according to action time 654 or 660. For instance, the UE may update or activate the parameters according to the value(s) 644 after a period of time, number of slots, or the like indicated by action time 654, 660. This action time 654, 660 may be fixed across multiple RRC IEs 402, such as a same 3 ms for each RRC IE in RRC configuration 610. Alternatively, the action time 654, 660 may be fixed with a different value depending on the RRC IE 402, such as 3 ms for one parameter in RRC configuration 610 but 3N slots for another parameter in RRC configuration 610. Alternatively, the action time 654, 660 may be a variable value indicated in message 632 for the associated RRC IE 402, such as 3 ms, 4 ms, 3N slots, 4N slots, or any other value the base station dynamically sets as the action time for that RRC IE.

In one example, the message indicates a correspondence between an action time and the value update or the activation update of the configuration parameter, the action time being different than an activation time for a same configuration parameter configured in another message from the first communications device lacking configuration parameter referencing. For instance, message 632 may indicate to UE 604 that the RRC IE 402 referenced via unique identifier 642 is to be updated or activated following action time 654 or 660, which action time may be different than an activation time 622 for this same RRC IE configured in message 620. Message 620 may be, for example, a non-flexible MAC-CE lacking pointers 502. For example, the action time 654, 660 associated with message 632 may be independent of, as well as different than, the activation time 622 associated with message 620 for a same encoded token 612 corresponding to a given RRC IE.

In one example, the message is an uplink message including one or more preferred values for the configuration parameter, and the data communicated with the second communications device is according to the value update or the activation update of one or more selected values from the one or more preferred values in a subsequent downlink message to the uplink message. For instance, message 624 may be an uplink MAC-CE, UCI, or other uplink control message including preferred parameter value(s) 628 for an RRC IE 402, and the UE may communicate data 662 with the base station based on selected, parameter value(s) 644 provided in message 632. For example, if the UE indicates a preference for a TRS bandwidth and periodicity of 100 MHz and 80 ms as preferred value(s) 628 in message 624, the base station may select this bandwidth and periodicity as parameter value(s) 644 and subsequently in message 632 indicate the UE to update or activate the corresponding parameters using the selected, parameter value(s) 644. The UE and base station may then communicate data 662 using the updated parameter values accordingly.

In on example, the message is an uplink message including a plurality of preferred values respectively for different configuration parameters in an order of descending or ascending priority, the data communicated with the second communications device is according to the value update or the activation update of a selected value from the plurality of preferred values for each of the different configuration parameters in a subsequent downlink message to the uplink message, and the selected values are indicated in the subsequent downlink message via at least one respective index to the plurality of preferred values. For instance, message 624 may be an uplink MAC-CE, UCI, or other uplink control message including multiple preferred parameter values 628 for RRC IEs 402 listed in an ascending or descending order of priority, and the UE may communicate data 662 with the base station based on selected, parameter values 644 provided in message 632. For example, if the UE indicates a preference for TRS bandwidths and periodicities of (100 MHz, 80 ms) and (50 MHz, 40 ms) in descending order of priority as preferred values 628 in message 624, the base station may select one of these bandwidth and periodicity pairs as parameter values 644 and subsequently in message 632 indicate the UE to update or activate the corresponding parameters using the selected, parameter values 644. For compactness, the base station may indicate the selected bandwidth and periodicity pair or parameter values 644 via an index 646 pointing to the pair in message 624, rather than expressly indicate the parameter values again. The UE and base station may then communicate data 662 using the updated parameter values accordingly.

In one example, the unique identifier may be encrypted according to a key associated with the configuration, and the message may include the indication of the encrypted unique identifier. For instance, unique identifier(s) 642 in message 632 may be encrypted using encryption key 512, which key may be obtained during a configuration process of RRC configuration 610.

In some examples, the configuration includes a plurality of encoded tokens including the encoded token, and in response to an indicated UE capability, one of: a subset of the encoded tokens are configured for configuration parameter referencing, or the plurality of encoded tokens are configured for configuration parameter referencing in the message. For instance, encoded tokens 612 may be assigned with unique identifier(s) 614 for only those RRC IEs 402 in certain wireless generations such as those subsequent to 5G but not including 5G, or for RRC IEs including and subsequent to 5G, which pointers 502 may be indicated to UEs with capability 606 for such pointer referencing.

In some examples, the configuration parameter may be from a data structure of a plurality of configuration parameters configured for configuration parameter referencing and the unique identifier is an index to the data structure, or the configuration may include a plurality of encoded tokens including the encoded token, and a subset of the encoded tokens associated with one or more specified configuration parameter modules are configured for configuration parameter referencing. For instance, RRC IEs 402 explicitly listed in enumerated data structure 514 for pointer referencing may be assigned or associated with unique identifiers 614 corresponding to indices to this data structure 514. Alternatively or additionally, RRC configuration 504 including different modules 648 of RRC IEs 402 may include encoded tokens 612, where the encoded tokens 612 in one of these modules 648 are assigned to unique identifiers 614 for pointer referencing.

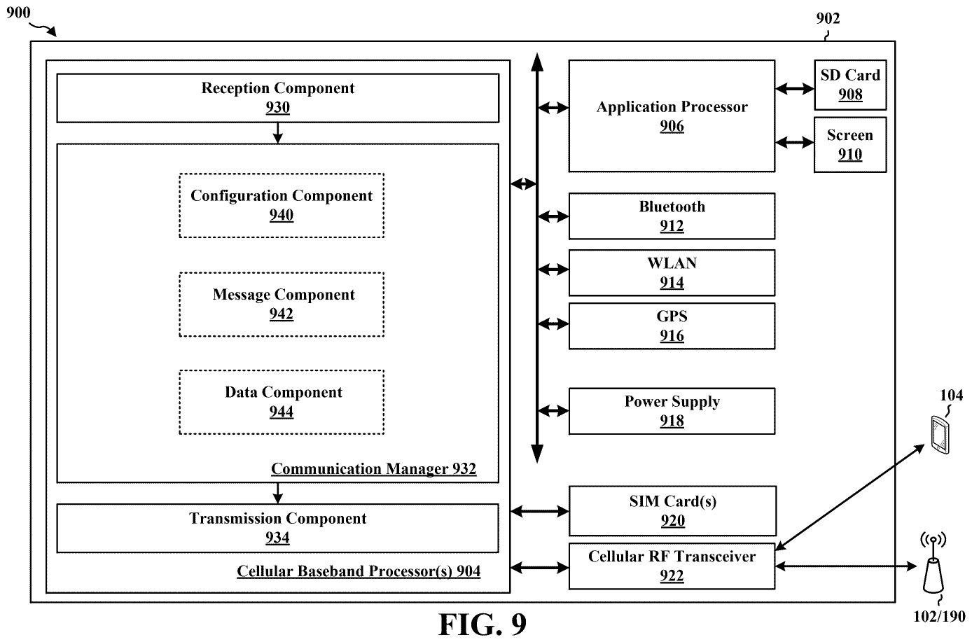

FIG. 9 is a diagram 900 illustrating an example of a hardware implementation for an apparatus 902. The apparatus 902 is a first communications device such as a UE and includes one or more cellular baseband processors 904 (also referred to as a modem) coupled to a cellular RF transceiver 922 and one or more subscriber identity modules (SIM) cards 920, an application processor 906 coupled to a secure digital (SD) card 908 and a screen 910, a Bluetooth module 912, a wireless local area network (WLAN) module 914, a Global Positioning System (GPS) module 916, and a power supply 918. The one or more cellular baseband processors 904 communicate through the cellular RF transceiver 922 with a second communications device such as the BS 102/180/disaggregated base station 181. For example, the cellular RF transceiver 922 may correspond to or include the transmitters 354TX, receivers 354RX, and antennas 352 of communications device 350.

The one or more cellular baseband processors 904 may each include a computer-readable medium/one or more memories. The computer-readable medium/one or more memories may be non-transitory. The one or more cellular baseband processors 904 are responsible for general processing, including the execution of software stored on the computer-readable medium/one or more memories individually or in combination. The software, when executed by the one or more cellular baseband processors 904, causes the one or more cellular baseband processors 904 to, individually or in combination, perform the various functions described supra. The computer-readable medium/one or more memories may also be used individually or in combination for storing data that is manipulated by the one or more cellular baseband processors 904 when executing software. The one or more cellular baseband processors 904 individually or in combination further include a reception component 930, a communication manager 932, and a transmission component 934. The communication manager 932 includes the one or more illustrated components. The components within the communication manager 932 may be stored in the computer-readable medium/one or more memories and/or configured as hardware within the one or more cellular baseband processors 904. The one or more cellular baseband processors 904 may be components of the communications device 350 and may individually or in combination include the one or more memories 360 and/or at least one of the one or more TX processors 368, at least one of the one or more RX processors 356, and at least one of the one or more controllers/processors 359. For example, the reception component 930 may include at least the one or more RX processors 356, the transmission component 934 may include at least the one or more TX processors 368, and the communication manager 932 may include at least the one or more controllers/processors 359. In one configuration, the apparatus 902 may be a modem chip and include just the one or more baseband processors 904, and in another configuration, the apparatus 902 may be the entire communications device (e.g., see communications device 350 of FIG. 3) and include the aforediscussed additional modules of the apparatus 902.

The communication manager 932 includes a configuration component 940 that is configured to, for example via reception component 930, receive, from a second communications device, a configuration including an encoded token, the encoded token being associated with a unique identifier for a configuration parameter, such as described in connection with block 702. The communication manager 932 may further include a message component 942 that is configured to, for example via reception component 930 or transmission component 934 respectively, receive from the second communications device, or transmit to the second communications device, a message including an indication of the unique identifier for the configuration parameter and one or more values associated with the configuration parameter, such as described in connection with block 704. The communication manager 932 may further include a data component 944 that is configured to, for example via reception component 930 or transmission component 934, communicate data with the second communications device according to a value update or an activation update of the one or more values associated with the configuration parameter referenced in the indication, such as described in connection with block 706.

The apparatus may include additional components that perform each of the blocks of the algorithm in the aforementioned flowchart of FIG. 7. As such, each block in the aforementioned flowchart of FIG. 7 may be performed by a component and the apparatus may include one or more of those components. The components may be one or more hardware components specifically configured to carry out the stated processes/algorithm, implemented by one or more processors individually or in combination configured to perform the stated processes/algorithm, stored within a computer-readable medium for implementation by one or more processors, or some combination thereof.

In one configuration, the apparatus 902, and in particular the one or more cellular baseband processors 904, includes means for receiving, from a second communications device, a configuration including an encoded token, the encoded token being associated with a unique identifier for a configuration parameter. The apparatus 902, and in particular the one or more cellular baseband processors 904, further includes means for receiving from the second communications device, or for transmitting to the second communications device, a message including an indication of the unique identifier for the configuration parameter and one or more values associated with the configuration parameter. The apparatus 902, and in particular the one or more cellular baseband processors 904, further includes means for communicating data with the second communications device according to a value update or an activation update of the one or more values associated with the configuration parameter referenced in the indication.

The aforementioned means may be one or more of the aforementioned components of the apparatus 902 configured to perform the functions recited by the aforementioned means. As described supra, the apparatus 902 may include the one or more TX Processors 368, the one or more RX Processors 356, and the one or more controllers/processors 359. As such, in one configuration, the aforementioned means may be at least one of the one or more TX Processors 368, at least one of the one or more RX Processors 356, or at least one of the one or more controllers/processors 359, individually or in any combination configured to perform the functions recited by the aforementioned means.

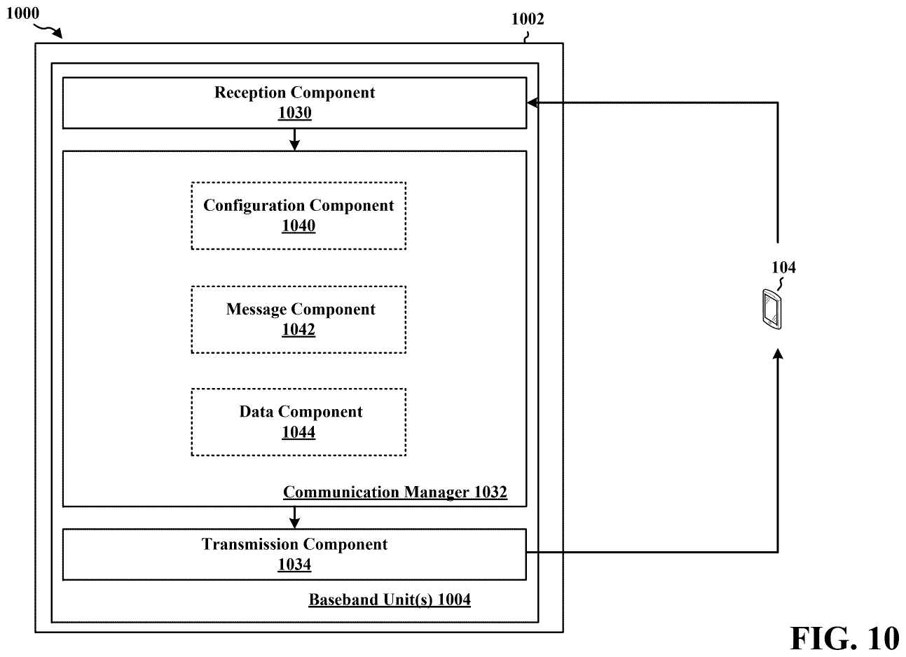

FIG. 10 is a diagram 1000 illustrating an example of a hardware implementation for an apparatus 1002. The apparatus 1002 is a first communications device, for instance, a network entity such as a base station, and includes one or more baseband units 1004. The one or more baseband units 1004 communicate through a cellular RF transceiver with a second communications device such as the UE 104. For example, the cellular RF transceiver may correspond to or include the transmitters 318TX, receivers 318RX, and antennas 320 of communications device 310.

The one or more baseband units 1004 may each include a computer-readable medium/one or more memories. The computer-readable medium/one or more memories may be non-transitory. The one or more baseband units 1004 are responsible for general processing, including the execution of software stored on the computer-readable medium/one or more memories individually or in combination. The software, when executed by the one or more baseband units 1004, causes the one or more baseband units 1004 to, individually or in combination, perform the various functions described supra. The computer-readable medium/one or more memories may also be used individually or in combination for storing data that is manipulated by the one or more baseband units 1004 when executing software. The one or more baseband units 1004 individually or in combination further include a reception component 1030, a communication manager 1032, and a transmission component 1034. The communication manager 1032 includes the one or more illustrated components. The components within the communication manager 1032 may be stored in the computer-readable medium/one or more memories and/or configured as hardware within the one or more baseband units 1004. The one or more baseband units 1004 may be components of the communications device 310 and may individually or in combination include the one or more memories 376 and/or at least one of the one or more TX processors 316, at least one of the one or more RX processors 370, and at least one of the one or more controllers/processors 375. For example, the reception component 1030 may include at least the one or more RX processors 370, the transmission component 1034 may include at least the one or more TX processors 316, and the communication manager 1032 may include at least the one or more controllers/processors 375.

The communication manager 1032 includes a configuration component 1040 that is configured to, for example via transmission component 1034, transmit, to a second communications device, a configuration including an encoded token, the encoded token being associated with a unique identifier for a configuration parameter, such as described in connection with block 802. The communication manager 1032 may further include a message component 1042 that is configured to, for example via transmission component 1034 or reception component 1030 respectively, transmit to the second communications device, or receive from the second communications device, a message including an indication of the unique identifier for the configuration parameter and one or more values associated with the configuration parameter, such as described in connection with block 804. The communication manager 1032 may further include a data component 1044 that is configured to, for example via transmission component 1034 or reception component 1030, communicate data with the second communications device according to a value update or an activation update of the one or more values associated with the configuration parameter referenced in the indication, such as described in connection with block 806.

The apparatus may include additional components that perform each of the blocks of the algorithm in the aforementioned flowchart of FIG. 8. As such, each block in the aforementioned flowchart of FIG. 8 may be performed by a component and the apparatus may include one or more of those components. The components may be one or more hardware components specifically configured to carry out the stated processes/algorithm, implemented by one or more processors individually or in combination configured to perform the stated processes/algorithm, stored within a computer-readable medium for implementation by one or more processors, or some combination thereof.

In one configuration, the apparatus 1002, and in particular the one or more baseband unit(s) 1004, includes means for transmitting, to a second communications device, a configuration including an encoded token, the encoded token being associated with a unique identifier for a configuration parameter. The apparatus 1002, and in particular the one or more baseband unit(s) 1004, further includes means for transmitting to the second communications device, or for receiving from the second communications device, a message including an indication of the unique identifier for the configuration parameter and one or more values associated with the configuration parameter. The apparatus 1002, and in particular the one or more baseband unit(s) 1004, further includes means for communicating data with the second communications device according to a value update or an activation update of the one or more values associated with the configuration parameter referenced in the indication.

The aforementioned means may be one or more of the aforementioned components of the apparatus 1002 configured to perform the functions recited by the aforementioned means. As described supra, the apparatus 1002 may include the one or more TX Processors 316, the one or more RX Processors 370, and the one or more controllers/processors 375. As such, in one configuration, the aforementioned means may be at least one of the one or more TX Processors 316, at least one of the one or more RX Processors 370, or at least one of the one or more controllers/processors 375, individually or in any combination configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, a processor, at least one processor, and/or one or more processors, individually or in combination, configured to perform or operable for performing a plurality of actions (such as the functions described supra) is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

Similarly as used herein, a memory, at least one memory, a computer-readable medium, and/or one or more memories, individually or in combination, configured to store or having stored thereon instructions executable by one or more processors for performing a plurality of actions (such as the functions described supra) is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, a computer-readable medium, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, a second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processors may in combination execute the respective subset of instruction to accomplish performing actions X, Y, and Z. Alternatively, a single processor may execute the instructions stored on a single memory, or distributed across multiple memories, to accomplish performing actions X, Y, and Z.

The following examples are illustrative only and may be combined with aspects of other embodiments or teachings described herein, without limitation.

Clause 1. An apparatus for wireless communication, comprising: one or more memories; and one or more processors each communicatively coupled with at least one of the one or more memories, the one or more processors, individually or in any combination, operable to cause the apparatus to: receive, from a communications device, a configuration including an encoded token, the encoded token being associated with a unique identifier for a configuration parameter; receive from the communications device, or transmit to the communications device, a message including an indication of the unique identifier for the configuration parameter and one or more values associated with the configuration parameter; and communicate data with the communications device according to a value update or an activation update of the one or more values associated with the configuration parameter referenced in the indication.

Clause 2. The apparatus of clause 1, wherein the message is a medium access control (MAC) control element (MAC-CE), a sidelink MAC-CE, downlink control information (DCI), uplink control information (UCI), or sidelink control information (SCI), and the indication of the unique identifier for the configuration parameter is included in a field of the message.

Clause 3. The apparatus of clause 1 or clause 2, wherein the encoded token is an abstract syntax notation one (ASN.1) encoded token corresponding to a single field or a sub-field of a structure or of a nested structure, and the encoded token is a variable name, a variable data type, or a variable name associated with a common variable data type.

Clause 4. The apparatus of any of clauses 1 to 3, wherein the unique identifier includes a next available index following a previous count of unique identifiers respectively for different configuration parameters, the previous count including a total of at least one group of configuration parameters.

Clause 5. The apparatus of any of clauses 1 to 4, wherein the configuration includes an assigned correspondence of encoded tokens with unique identifiers across different specified sets of configuration parameters or separately for the different specified sets of configuration parameters.

Clause 6. The apparatus of any of clauses 1 to 5, wherein the configuration includes a plurality of encoded tokens, and each of at least a subset of the encoded tokens is associated with a different unique identifier for a respective configuration parameter.

Clause 7. The apparatus of any of clauses 1 to 6, wherein the configuration includes an assigned correspondence of the encoded token with the unique identifier, and the association includes a parser built mapping of the unique identifier to the configuration parameter.

Clause 8. The apparatus of any of clauses 1 to 7, wherein the configuration includes a plurality of encoded tokens, and each of a subset of the encoded tokens for a common data type is associated with a different unique identifier for a respective configuration parameter.

Clause 9. The apparatus of any of clauses 1 to 8, wherein in response to the encoded token associated with the unique identifier for the configuration parameter corresponding to a field of a complex data type, the association includes a first parser built mapping of the unique identifier to the configuration parameter and a second parser built mapping of a primitive data type corresponding to the encoded token to the configuration parameter.

Clause 10. The apparatus of any of clauses 1 to 9, wherein the configuration includes a plurality of encoded tokens corresponding to different fields of a complex data type, and in response to each of the encoded tokens being for a primitive data type within the complex data type, each of the encoded tokens is associated with a different unique identifier for configuration parameter referencing.

Clause 11. The apparatus of any of clauses 1 to 10, wherein the unique identifier indicates a data type corresponding to the encoded token, and the message includes a quantity of bits for indicating the unique identifier with the data type.

Clause 12. The apparatus of any of clauses 1 to 11, wherein the message is the configuration, and the indication of the unique identifier for the configuration parameter is configured in another encoded token of the configuration.

Clause 13. The apparatus of any of clauses 1 to 12, wherein the configuration includes an assigned correspondence of encoded tokens with unique identifiers separately for different configuration parameter modules, and the message indicates one of the different configuration parameter modules corresponding to the encoded token.

Clause 14. The apparatus of any of clauses 1 to 13, wherein the configuration includes an assigned correspondence of encoded tokens with unique identifiers separately for different configuration parameters associated with a common attribute, and the message indicates the common attribute corresponding to the encoded token.

Clause 15. The apparatus of any of clauses 1 to 14, wherein the configuration includes

an assigned correspondence of the encoded token with the unique identifier according to one or more rules, and the association includes a parser built mapping of the unique identifier to the configuration parameter.

Clause 16. The apparatus of any of clauses 1 to 15, wherein the message indicates to perform the value update or the activation update of the one or more values associated with the configuration parameter referenced in the indication following an action time.

Clause 17. The apparatus of any of clauses 1 to 16, wherein the configuration parameter corresponds to a field indicating an activation state for another parameter in the configuration, and the message indicates the unique identifier and the one or more values for the field indicating the activation state.

Clause 18. The apparatus of any of clauses 1 to 17, wherein the message includes a field dedicated for activation or deactivation of the configuration parameter in the configuration, and the configuration parameter is from a data structure of a plurality of configuration parameters configured for activated configuration parameter referencing.

Clause 19. The apparatus of any of clauses 1 to 18, wherein the message indicates a plurality of unique identifiers for different configuration parameters and one or more values respectively associated with the different configuration parameters, the different configuration parameters being respectively associated with different action times for the value update or the activation update.

Clause 20. The apparatus of any of clauses 1 to 19, wherein the message indicates a correspondence between an action time and the value update or the activation update of the configuration parameter, the action time is in a unit of time or quantity of slots, the value update or the activation update follows the action time, and the action time starts after an acknowledgement of a code block or a transport block including the message or a code block group including the message.

Clause 21. The apparatus of any of clauses 1 to 20, wherein the message indicates to perform the value update or the activation update of the one or more values associated with the configuration parameter referenced in the indication following an action time, the action time being fixed for different configuration parameters, fixed specifically for the configuration parameter, or variably indicated in the message for the configuration parameter.

Clause 22. The apparatus of any of clauses 1 to 21, wherein the message indicates a correspondence between an action time and the value update or the activation update of the configuration parameter, the action time being different than an activation time for a same configuration parameter configured in another message from the communications device lacking configuration parameter referencing.

Clause 23. The apparatus of any of clauses 1 to 22, wherein the message is an uplink message including one or more preferred values for the configuration parameter, and the data communicated with the communications device is according to the value update or the activation update of one or more selected values from the one or more preferred values in a subsequent downlink message to the uplink message.

Clause 24. The apparatus of any of clauses 1 to 23, wherein the message is an uplink message including a plurality of preferred values respectively for different configuration parameters in an order of descending or ascending priority, the data communicated with the communications device is according to the value update or the activation update of a selected value from the plurality of preferred values for each of the different configuration parameters in a subsequent downlink message to the uplink message, and the selected values are indicated in the subsequent downlink message via at least one respective index to the plurality of preferred values.

Clause 25. The apparatus of any of clauses 1 to 24, wherein the unique identifier is encrypted according to a key associated with the configuration, and the message includes the indication of the encrypted unique identifier.

Clause 26. The apparatus of any of clauses 1 to 25, wherein the configuration includes a plurality of encoded tokens including the encoded token, and in response to an indicated UE capability, one of: a subset of the encoded tokens are configured for configuration parameter referencing, or the plurality of encoded tokens are configured for configuration parameter referencing in the message.

Clause 27. The apparatus of any of clauses 1 to 26, wherein one of: the configuration parameter is from a data structure of a plurality of configuration parameters configured for configuration parameter referencing and the unique identifier is an index to the data structure, or the configuration includes a plurality of encoded tokens including the encoded token, and a subset of the encoded tokens associated with one or more specified configuration parameter modules are configured for configuration parameter referencing.

Clause 28. A method of wireless communication performable at a first communications device, comprising: receiving, from a second communications device, a configuration including an encoded token, the encoded token being associated with a unique identifier for a configuration parameter; receiving from the second communications device, or transmitting to the second communications device, a message including an indication of the unique identifier for the configuration parameter and one or more values associated with the configuration parameter; and communicating data with the second communications device according to a value update or an activation update of the one or more values associated with the configuration parameter referenced in the indication.

Clause 29. An apparatus for wireless communication, comprising: one or more memories; and one or more processors each communicatively coupled with at least one of the one or more memories, the one or more processors, individually or in any combination, operable to cause the apparatus to: transmit, to a communications device, a configuration including an encoded token, the encoded token being associated with a unique identifier for a configuration parameter; transmit to the communications device, or receive from the communications device, a message including an indication of the unique identifier for the configuration parameter and one or more values associated with the configuration parameter; and communicate data with the communications device according to a value update or an activation update of the one or more values associated with the configuration parameter referenced in the indication.

Clause 30. A method of wireless communication performable at a first communications device, comprising: transmitting, to a second communications device, a configuration including an encoded token, the encoded token being associated with a unique identifier for a configuration parameter; transmitting to the second communications device, or receiving from the second communications device, a message including an indication of the unique identifier for the configuration parameter and one or more values associated with the configuration parameter; and communicating data with the second communications device according to a value update or an activation update of the one or more values associated with the configuration parameter referenced in the indication.

What is claimed is:

1. An apparatus for wireless communication, comprising:
one or more memories; and
one or more processors each communicatively coupled with at least one of the one or more memories, the one or more processors, individually or in any combination, operable to cause the apparatus to:
receive, from a communications device, a configuration including an encoded token, the encoded token being associated with a unique identifier for a configuration parameter;
receive from the communications device, or transmit to the communications device, a message including an indication of the unique identifier for the configuration parameter and one or more values associated with the configuration parameter; and
communicate data with the communications device according to a value update or an activation update of the one or more values associated with the configuration parameter referenced in the indication.

2. The apparatus of claim 1, wherein the message is a radio resource control (RRC) message, a medium access control (MAC) control element (MAC-CE), a sidelink MAC-CE, downlink control information (DCI), uplink control information (UCI), or sidelink control information (SCI), and the indication of the unique identifier for the configuration parameter is included in a field of the message.

3. The apparatus of claim 1, wherein the encoded token is an abstract syntax notation one (ASN.1) encoded token corresponding to a single field or a sub-field of a structure or of a nested structure or corresponding to a medium access control (MAC) layer defined variable or a physical layer defined variable in the structure or the nested structure, and the encoded token is a variable name, a variable data type, or a variable name associated with a common variable data type.

4. The apparatus of claim 1, wherein the unique identifier includes a next available index following a previous count of unique identifiers respectively for different configuration parameters, the previous count including a total of at least one group of configuration parameters.

5. The apparatus of claim 1, wherein the configuration includes an assigned correspondence of encoded tokens with unique identifiers across different specified sets of configuration parameters or separately for the different specified sets of configuration parameters.

6. The apparatus of claim 1, wherein the configuration includes a plurality of encoded tokens, and each of at least a subset of the encoded tokens is associated with a different unique identifier for a respective configuration parameter.

7. The apparatus of claim 1, wherein the configuration includes an assigned correspondence of the encoded token with the unique identifier, and the association includes a parser built mapping of the unique identifier to the configuration parameter.

8. The apparatus of claim 1, wherein the configuration includes a plurality of encoded tokens, and each of a subset of the encoded tokens for a common data type is associated with a different unique identifier for a respective configuration parameter.

9. The apparatus of claim 1, wherein in response to the encoded token associated with the unique identifier for the configuration parameter corresponding to a field of a complex data type, the association includes a first parser built mapping of the unique identifier to the configuration parameter and a second parser built mapping of a primitive data type corresponding to the encoded token to the configuration parameter.

10. The apparatus of claim 1, wherein the configuration includes a plurality of encoded tokens corresponding to different fields of a complex data type, and in response to each of the encoded tokens being for a primitive data type within the complex data type, each of the encoded tokens is associated with a different unique identifier for configuration parameter referencing.

11. The apparatus of claim 1, wherein the unique identifier indicates a data type corresponding to the encoded token, and the message includes a quantity of bits for indicating the unique identifier with the data type.

12. The apparatus of claim 1, wherein the message is the configuration, and the indication of the unique identifier for the configuration parameter is configured in another encoded token of the configuration.

13. The apparatus of claim 1, wherein the configuration includes an assigned correspondence of encoded tokens with unique identifiers separately for different configuration parameters associated with a common attribute, and the message indicates the common attribute corresponding to the encoded token.

14. The apparatus of claim 13, wherein the common attribute includes at least one of:
a module associated with the configuration parameter,
a data type corresponding to the encoded token,
a medium access control (MAC) control element (MAC-CE) or a downlink control information (DCI) configured to update the configuration parameter,
an update behavior associated with the configuration parameter,
a UE capability for an update of the configuration parameter,
a downlink association or an uplink association with the configuration parameter, or
an indication of a release associated with the unique identifier for the configuration parameter.

15. The apparatus of claim 1, wherein the configuration includes an assigned correspondence of the encoded token with the unique identifier according to one or more rules, and the association includes a parser built mapping of the unique identifier to the configuration parameter.

16. The apparatus of claim 1, wherein the message indicates to perform the value update or the activation update of the one or more values associated with the configuration parameter referenced in the indication following an action time.

17. The apparatus of claim 1, wherein the configuration parameter corresponds to a field indicating an activation state for another parameter in the configuration, and the message indicates the unique identifier and the one or more values for the field indicating the activation state.

18. The apparatus of claim 1, wherein the message includes a field dedicated for activation or deactivation of the configuration parameter in the configuration, and the configuration parameter is from a data structure of a plurality of configuration parameters configured for activated configuration parameter referencing.

19. The apparatus of claim 1, wherein the message indicates a plurality of unique identifiers for different configuration parameters and one or more values respectively associated with the different configuration parameters, the different configuration parameters being respectively associated with different action times for the value update or the activation update.

20. The apparatus of claim 1, wherein the message indicates a correspondence between an action time and the value update or the activation update of the configuration parameter, the action time is in a unit of time or quantity of slots, the value update or the activation update follows the action time, and the action time starts after an acknowledgement of a code block or a transport block including the message or a code block group including the message.

21. The apparatus of claim 1, wherein the message indicates to perform the value update or the activation update of the one or more values associated with the configuration parameter referenced in the indication following an action time, the action time being fixed for different configuration parameters, fixed specifically for the configuration parameter, or variably indicated in the message for the configuration parameter.

22. The apparatus of claim 1, wherein the message indicates a correspondence between an action time and the value update or the activation update of the configuration parameter, the action time being different than an activation time for a same configuration parameter configured in another message from the communications device lacking configuration parameter referencing.

23. The apparatus of claim 1, wherein the message is an uplink message including one or more preferred values for the configuration parameter, and the data communicated with the communications device is according to the value update or the activation update of one or more selected values from the one or more preferred values in a subsequent downlink message to the uplink message.

24. The apparatus of claim 1, wherein the message is an uplink message including a plurality of preferred values respectively for different configuration parameters in an order of descending or ascending priority, the data communicated with the communications device is according to the value update or the activation update of a selected value from the plurality of preferred values for each of the different configuration parameters in a subsequent downlink message to the uplink message, and the selected values are indicated in the subsequent downlink message via at least one respective index to the plurality of preferred values.

25. The apparatus of claim 1, wherein the unique identifier is encrypted according to a key associated with the configuration, and the message includes the indication of the encrypted unique identifier.

26. The apparatus of claim 1, wherein the configuration includes a plurality of encoded tokens including the encoded token, and in response to an indicated user equipment (UE) capability, one of:
a subset of the encoded tokens are configured for configuration parameter referencing, or
the plurality of encoded tokens are configured for configuration parameter referencing in the message.

27. The apparatus of claim 1, wherein one of:
the configuration parameter is from a data structure of a plurality of configuration parameters configured for configuration parameter referencing and the unique identifier is an index to the data structure, or
the configuration includes a plurality of encoded tokens including the encoded token, and a subset of the encoded tokens associated with one or more specified configuration parameter modules are configured for configuration parameter referencing.

28. A method of wireless communication performable at a first communications device, comprising:
receiving, from a second communications device, a configuration including an encoded token, the encoded token being associated with a unique identifier for a configuration parameter;
receiving from the second communications device, or transmitting to the second communications device, a message including an indication of the unique identifier for the configuration parameter and one or more values associated with the configuration parameter; and
communicating data with the second communications device according to a value update or an activation update of the one or more values associated with the configuration parameter referenced in the indication.

29. An apparatus for wireless communication, comprising:
one or more memories; and
one or more processors each communicatively coupled with at least one of the one or more memories, the one or more processors, individually or in any combination, operable to cause the apparatus to:
transmit, to a communications device, a configuration including an encoded token, the encoded token being associated with a unique identifier for a configuration parameter;
transmit to the communications device, or receive from the communications device, a message including an indication of the unique identifier for the configuration parameter and one or more values associated with the configuration parameter; and
communicate data with the communications device according to a value update or an activation update of the one or more values associated with the configuration parameter referenced in the indication.

30. A method of wireless communication performable at a first communications device, comprising:
transmitting, to a second communications device, a configuration including an encoded token, the encoded token being associated with a unique identifier for a configuration parameter;
transmitting to the second communications device, or receiving from the second communications device, a message including an indication of the unique identifier for the configuration parameter and one or more values associated with the configuration parameter; and
communicating data with the second communications device according to a value update or an activation update of the one or more values associated with the configuration parameter referenced in the indication.
